(19) United States
(12) Patent Application Publication
(10) Pub. No.: US 2008/0083778 A1
(43) Pub. Date: Apr. 10, 2008

(54) Dispenser for Toothpaste or Other Pastes, Gels, or Fluids

(76) Inventor: Hannah Ji-In Chung, Lawrenceville, GA (US)

Correspondence Address: SAM S. HAN, PH.D., 330 BLOOMBRIDGE WAY, NW, MARIETTA, GA, 30066, US

(21) Appl. No.: 11/867,731

(22) Filed: Oct. 5, 2007

Related U.S. Application Data
(60) Provisional application No. 60/828,953, filed on Oct. 10, 2006.

(51) Int. Cl. B65D 35/00; B67D 3/00

(52) U.S. Cl. 222/107; 220/351; 222/559

(57) ABSTRACT

Dispensers for viscous fluids are shown. Also, various caps that can be used on such dispensers are shown. In one embodiment, the dispenser has creases along the side of the dispenser. The creases permit the side to fold inwardly as a viscous fluid is dispensed from the dispenser. In another embodiment, a cap for a dispenser is shown. The cap comprises a base and a lid, which are slidably coupled to each other.

### CROSS REFERENCE TO RELATED APPLICATIONS

This application claims the benefit of U.S. provisional patent application Ser. No. 60/828,953, filed 2006 Oct. 10, having the title TOOTHPASTE TUBE, which is incorporated herein by reference in its entirety.

### FIELD OF THE INVENTION

The present disclosure relates generally to dispensers and, more particularly, to dispensers for paste, gels, or other viscous and non-viscous liquids.

### BACKGROUND

Conventional toothpaste tubes have either twist-off caps or flip-top caps. Twist-off caps typically permit users to remove or replace the caps by twisting the cap relative to the tube. Twist-off caps are not amenable to single-handed operation, and typically require a user to use two hands to remove the cap. Namely, one hand to hold the tube while the other hand unscrews (or twists) the cap.

Flip-top caps have hinged mechanisms that permit users to open and close the cap using one hand. Toothpaste often accumulates at the opening of the flip-top cap, and the build-up of the toothpaste over time prevents the flip-top cap from properly closing.

A heretofore unaddressed need exists in the industry to address one or more of these deficiencies and inadequacies.

### Definitions

For clarity, several of the terms, which are used throughout the written description and the claims, are defined below:

“Cap” is defined as any covering or closure to the opening of the dispenser.

“Couple” shall mean to connect, link, or join two or more items, either directly or indirectly, such that the items have a mutual influence on each other.

“Dispenser” is defined as any container that is suitable for storing and dispensing pastes, gels, or other fluids. The dispenser has at least one opening through which the paste, gel, or other fluid can be dispensed. One non-limiting example of a dispenser is a toothpaste tube.

“Fluid” is defined as any substance that deforms under an applied stress regardless of the magnitude of the applied stress.

“Grip” is defined as any frictional hold that provides increased traction during wet or dry conditions.

“Longitudinal” is defined as a direction that is substantially parallel to a major axis of an object.

“Or” is defined broadly to encompass the conjunctive. For example, the phrase “toothpaste or gel” shall be construed to encompass “toothpaste” and “gel” separately as well as “toothpaste and gel” collectively. Should the intent be to use “or” in the disjunctive, the context will clearly identify it as being disjunctive, such as, for example, “either toothpaste or gel, but not both.”

“Peg” is defined as any protrusion. One non-limiting example of a peg is a tongue in a tongue-and-groove assembly.

“Stump” is defined as any protrusion that facilitates holding or gripping.

“Toothpaste” is defined as any paste, gel, or fluid that can be used for dental hygiene.

“Track” is defined as any groove, aisle, conduit, or other concavity that slidably couples with the peg. One non-limiting example of a track is a groove in a tongue-and-groove assembly.

“Transverse” is defined as a direction that is substantially parallel to a minor axis of an object.

“Tube” and “dispenser” are defined synonymously. In other words, the term can be used interchangeably with the term dispenser.

“Viscous fluid” is defined as a fluid that has a viscosity that is greater than ten (10) pascal-seconds (Pa-s), or 10,000 centipoise (cps).

### SUMMARY

The present disclosure shows dispensers for viscous fluids, such as, for example, toothpaste. Also shown are various caps that can be used on such dispensers. Briefly described, in one embodiment, the dispenser includes creases along a side of the dispenser. The creases permit the side to fold inwardly as a viscous fluid is dispensed from the dispenser. In another embodiment, a cap for a dispenser is shown. The cap comprises a base and a lid, which are slidably coupled to each other.

Other systems, methods, features, and advantages will be or become apparent to one with skill in the art upon examination of the following drawings and detailed description. It is intended that all such additional systems, methods, features, and advantages be included within this description.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A through 1G (collectively, “FIG. 1”) show one embodiment of a base of a cap for a toothpaste tube.

FIGS. 2A through 2F (collectively, “FIG. 2”) shows one embodiment of a lid that couples with the base shown in FIGS. 1A through 1G.

FIGS. 3A through 3G (collectively, “FIG. 3”) show another embodiment of a base of a cap for a toothpaste tube.

FIGS. 4A through 4F (collectively, “FIG. 4”) show one embodiment of a lid that couples with the base shown in FIGS. 3A through 3G.

FIGS. 5A through 5G (collectively, “FIG. 5”) show a third embodiment of a base of a cap for a toothpaste tube.

FIGS. 6A through 6G (collectively, “FIG. 6”) show one embodiment of a lid that couples to the base shown in FIGS. 5A through 5G.

FIGS. 7A through 7G (collectively, “FIG. 7”) show a fourth embodiment of a base of a cap for a toothpaste tube.

FIGS. 8A through 8G (collectively, “FIG. 8”) show one embodiment of a lid that couples to the base shown in FIGS. 7A through 7G.

FIGS. 9A through 9F (collectively, “FIG. 9”) show a fifth embodiment of a base of a cap for a toothpaste tube.

FIGS. 10A through 10G (collectively, “FIG. 10”) show one embodiment of a lid that couples to the base shown in FIGS. 9A through 9F.

FIGS. 11A through 11G (collectively, “FIG. 11”) show a sixth embodiment of a base of a cap for a toothpaste tube.

FIGS. 12A through 12G (collectively, “FIG. 12”) show one embodiment of a lid that couples to the base shown in FIGS. 11A through 11G.

FIGS. 13A through 13G (collectively, “FIG. 13”) show a seventh embodiment of a base of a cap for a toothpaste tube.

FIGS. 14A through 14F (collectively, “FIG. 14”) show one embodiment of a lid that couples to the base shown in FIGS. 13A through 13G.

FIGS. 15A through 15H (collectively, “FIG. 15”) show an eighth embodiment of a base of a cap for a toothpaste tube.

FIGS. 16A through 16G (collectively, “FIG. 16”) show one embodiment of a lid that couples to the base shown in FIGS. 15A through 15H.

FIGS. 17A through 17D (collectively, “FIG. 17”) show one embodiment of a toothpaste tube.

FIGS. 18A through 18D (collectively, “FIG. 18”) show another embodiment of a toothpaste tube.

FIGS. 19A through 19D (collectively, “FIG. 19”) show a third embodiment of a toothpaste tube.

FIGS. 20A through 20H (collectively, “FIG. 20”) show a ninth embodiment of a base of a cap for a toothpaste tube.

FIGS. 21A through 21G (collectively, “FIG. 21”) show one embodiment of a lid that couples to the base shown in FIGS. 20A through 20H.

FIGS. 22A through 22D (collectively, “FIG. 22”) show a fourth embodiment of a toothpaste tube.

FIGS. 23A through 23G (collectively, “FIG. 23”) show a tenth embodiment of a base of a cap for a toothpaste tube.

FIGS. 24A through 24G (collectively, “FIG. 24”) show one embodiment of a lid that couples to the base of FIGS. 23A through 23G.

FIGS. 25A through 25D (collectively, “FIG. 25”) show a fifth embodiment of a toothpaste tube.

FIGS. 26A through 26F (collectively, “FIG. 26”) show an eleventh embodiment of a base of a cap for a toothpaste tube.

FIGS. 27A through 27F (collectively, “FIG. 27”) show one embodiment of a lid that couples to the base of FIGS. 26A through 26F.

FIGS. 28A through 28D (collectively, “FIG. 28”) show a sixth embodiment of a toothpaste tube.

FIGS. 29A and 29B (collectively, “FIG. 29”) show one embodiment of a dispenser having a cap, where a base and a lid of the cap are slidably coupled to each other.

FIGS. 30A through 30J (collectively, “FIG. 30”) show various embodiments of grips for different lids of caps.

### DETAILED DESCRIPTION OF THE EMBODIMENTS

Reference is now made in detail to the description of the embodiments as illustrated in the drawings. While several embodiments are described in connection with these drawings, there is no intent to limit the invention to the embodiment or embodiments disclosed herein. On the contrary, the intent is to cover all alternatives, modifications, and equivalents.

As noted above, conventional toothpaste dispensers employ either a twist-off cap or a flip-top cap, both of which suffer from functional deficiencies. Unlike conventional toothpaste dispensers, the inventive dispensers include a cap where the base and lid of the cap are slidably coupled to each other.

### Example of Assembled Dispenser and Cap

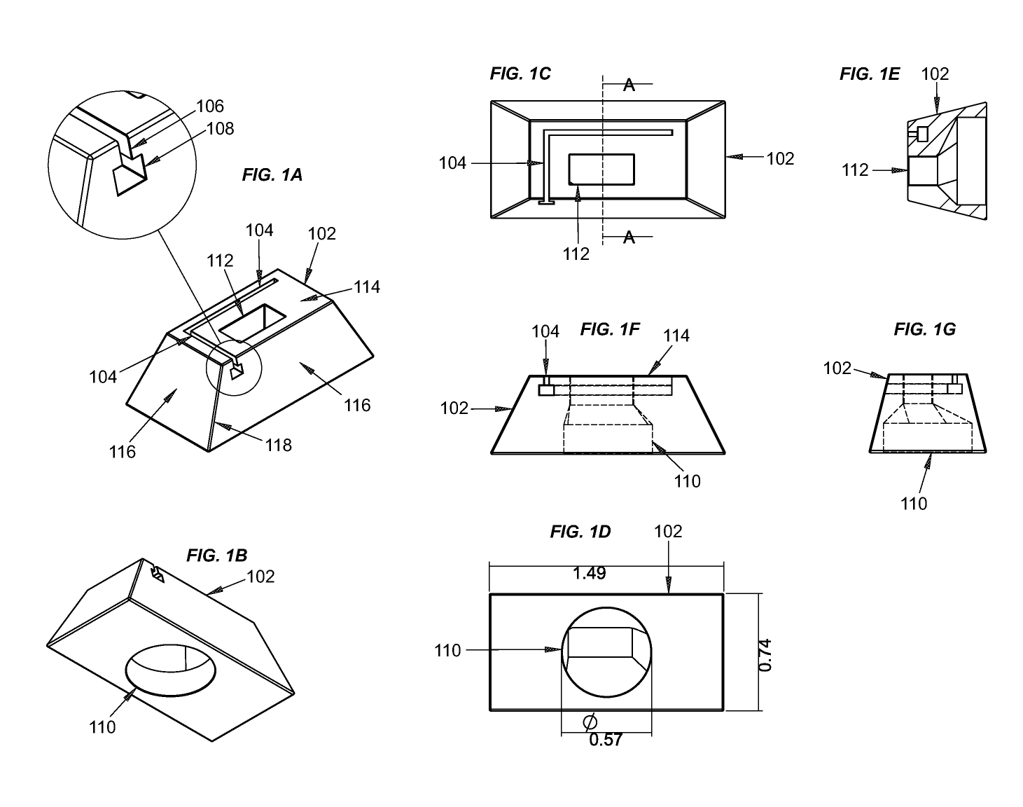

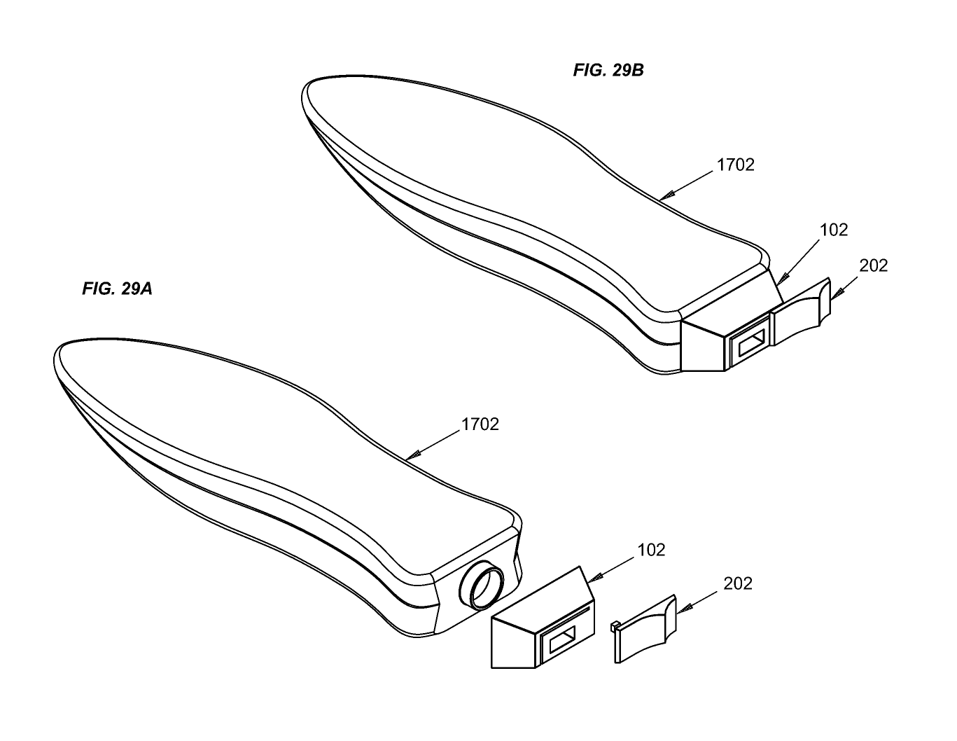

FIGS. 29A and 29B show one embodiment of a dispenser 1702 (or tube) having a cap, where a base 102 and a lid 202 of the cap are slidably coupled to each other. Specifically, FIG. 29A shows the cap and tube 1702 disassembled, while FIG. 29B shows the cap and tube 1702 assembled. As shown in FIGS. 29A and 29B, the lid 202 and base 102 are configured to couple to each other, such that the lid 202 slides with reference to the base 102, thereby permitting the user to open and close the tube 1702. The particular cap and tube 1702 are shown in greater detail in FIGS. 1A through 1G, 2A through 2F, and 17A through 17D.

### First Embodiment of Dispenser (Model CT (Curved Tube))

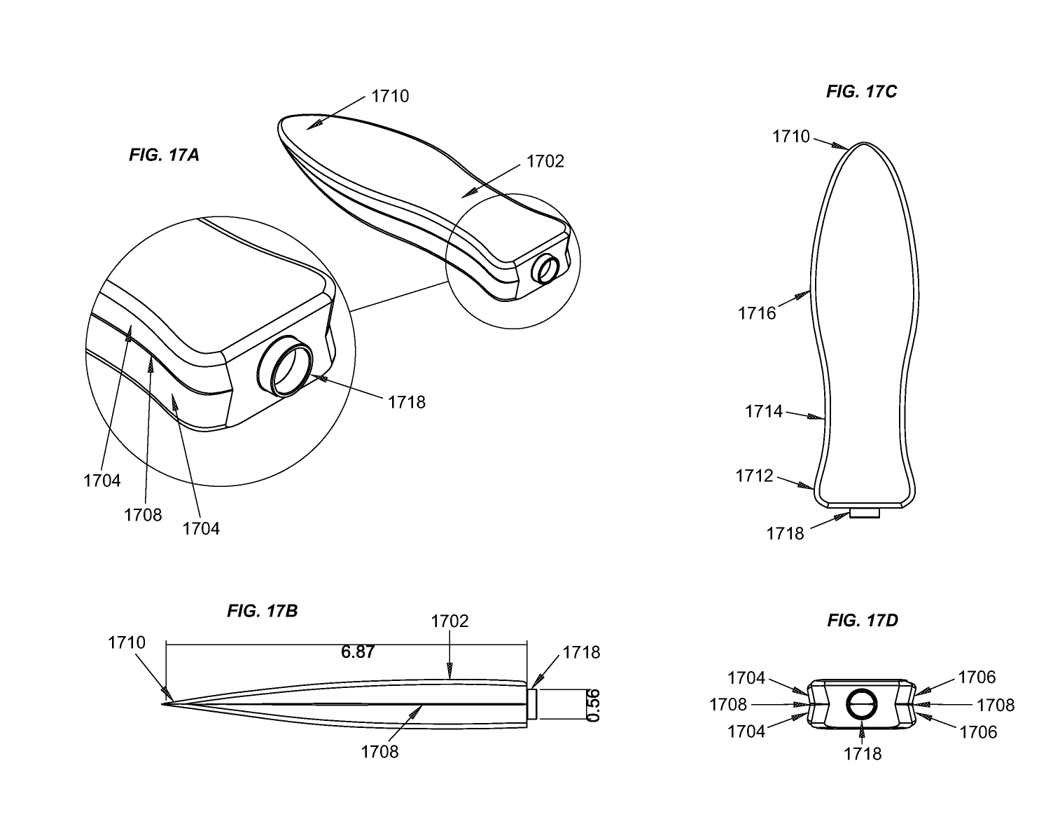

FIGS. 17A through 17D show one embodiment of a toothpaste tube 1702. For convenience, the tube 1702 of FIGS. 17A through 17D is referred to herein as a curved tube (or Model CT) 1702.

FIG. 17A is a perspective view of the tube 1702, also showing a detailed view of an opening 1718, and various creases 1708 along the side of the tube 1702. FIG. 17B is a side view of Model CT 1702, showing the tube 1702 tapering toward the back 1710 of the tube 1702. FIG. 17B also shows a crease 1708 that facilitates folding of the tube 1702. FIG. 17C shows a top view of Model CT 1702, showing curves 1712, 1714, 1716 along the side of the tube 1702. FIG. 17D shows a front view of Model CT 1702, showing the opening 1718 at the front end of the tube 1702.

Model CT 1702 is configured to fold neatly flat at the end of its life cycle. Specifically, in the embodiment of FIGS. 17A through 17D, tube 1702 has two facets 1704 on one side, which are substantially symmetrically disposed about a crease 1708. Similarly, the tube 1702 has two facets 1706 on the other side, which are substantially symmetrically disposed about a crease 1708. The facets 1704, 1706 fold inwardly along their respective creases 1708 as toothpaste (or other viscous fluid like, for example, ointment or gel) is squeezed out of the tube 1702.

Model CT 1702 is designed in such a way that it tapers toward the back 1710. For this particular embodiment of Model CT 1702, the left and right sides of the tube have three distinct curves: a first curve 1712 located near the opening 1718; a second curve 1714 located near the middle of the tube 1702; and a third curve 1716 located toward the back end of the tube 1702.

The opening 1718 is located at the front of the tube 1702, where the tube 1702 will connect with a base of a cap (not shown in FIGS. 17A through 17D). As will be discussed below, Model CT 1702 is compatible with several different cap models (not shown in FIGS. 17A through 17D).

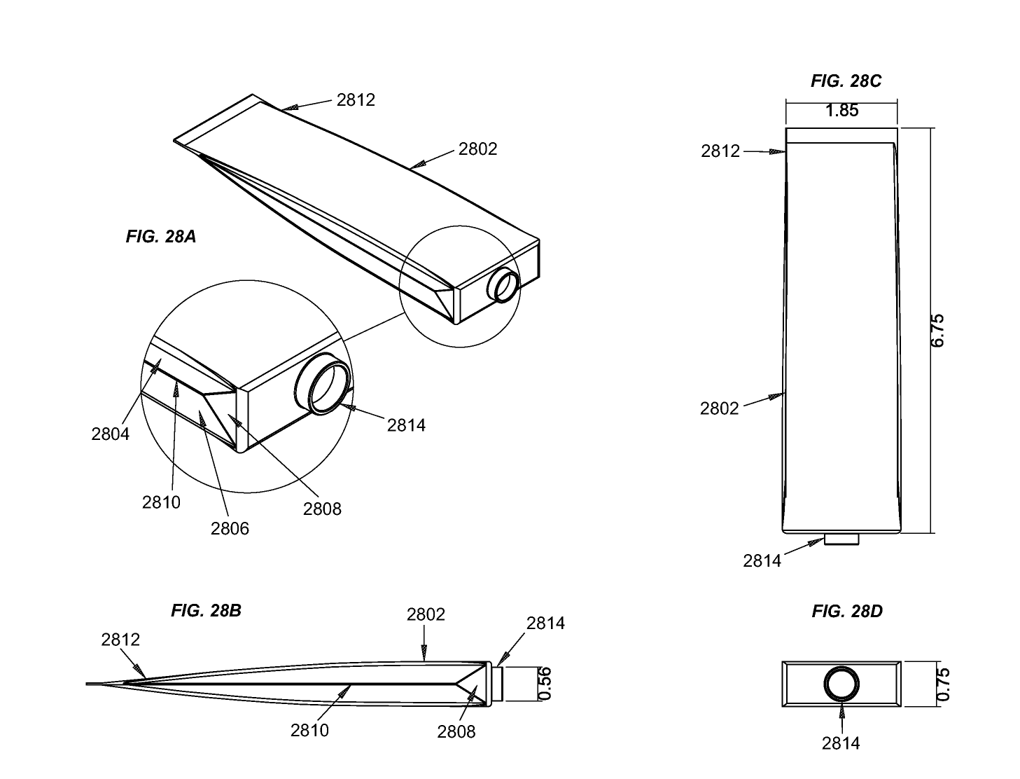

While one embodiment of Model CT 1702 shows specific locations and configurations for the curves 1712, 1714, 1716, it should be appreciated that the size, number, and location of the curves can be varied without detrimentally affecting the functional features of the tube 1702. Additionally, while not shown in great detail, it should be appreciated by one having ordinary skill in the art that the cap (not shown in FIGS. 17A through 17D) can either twist (or screw) onto the front near the opening 1718 or snap onto the front. Also, it should be appreciated that the sides of the tube 1702 can include more facets and more creases without altering the advantageous features of the tube 1702. For some embodiments, the sides of the tube 1702 may also include an additional facet (not shown) near the end of the tube 1702 near the opening 1718, which will facilitate folding of the sides, similar to the triangular facet 2808 shown in FIG. 28B, below. Furthermore, while specific dimensions are shown in FIG. 17B, it should be appreciated that these dimensions are shown only for illustrative purposes, and are not intended to be limiting on the invention.

### Second Embodiment of Dispenser (Model RT (Rectangular Tube))

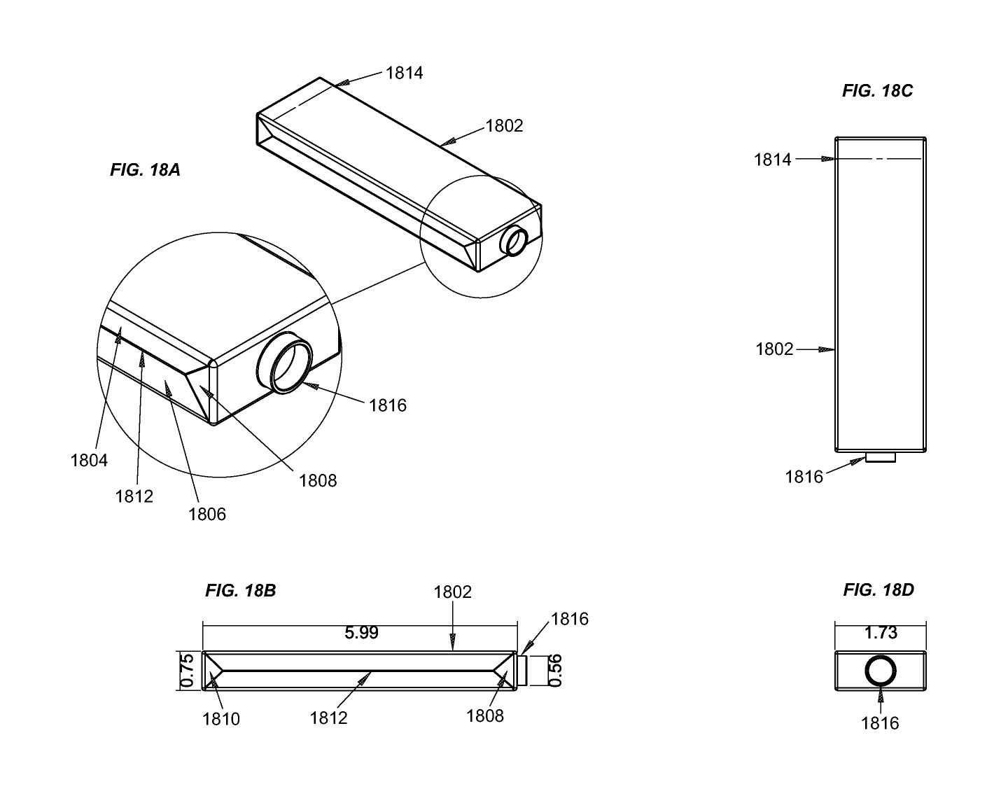

FIGS. 18A through 18D show another embodiment of a toothpaste tube 1802. For convenience, the tube 1802 of FIGS. 18A through 18D is referred to herein as a rectangular tube (or Model RT) 1802.

FIG. 18A is a perspective view of the tube 1802, also showing a detailed view of an opening 1816, and various creases 1812 along the side of the tube 1802. FIG. 18B is a side view of Model RT 1802, showing facets 1808, 1810 of the tube 1802, which will facilitate folding of the tube 1802. FIG. 18C shows a top view of Model RT 1802, showing the rectangular shape of the tube 1802 and an additional crease 1814 toward the back of the tube 1802, which also facilitates substantially-flat folding of the tube 1802. FIG. 18D shows a front view of Model RT 1802, showing the opening 1816 at the front end of the tube 1802.

Model RT 1802 is configured to fold neatly flat at the end of its life cycle, much like a gift bag can fold flat. Specifically, in the embodiment of FIGS. 18A through 18D, tube 1802 has four facets 1804, 1806, 1808, 1810 on one side. Similarly, the tube 1802 has four facets (not shown) on the other side, which are configured substantially similarly as the facets 1804, 1806, 1808, 1810. The facets 1804, 1806, 1808, 1810 fold inwardly along their respective creases 1812 as toothpaste (or other viscous fluid like, for example, ointment or gel) is squeezed out of the tube 1802.

Unlike Model CT 1702, Model RT 1802 does not taper toward the back. The opening 1816 is located at the front of the tube 1802, where the tube 1802 will connect with a base of a cap (not shown in FIGS. 18A through 18D). As will be discussed below, Model RT 1802 is compatible with several different cap models (not shown in FIGS. 18A through 18D).

Similar to Model RT 1702, it should be appreciated by one having ordinary skill in the art that the cap (not shown in FIGS. 18A through 18D) can either twist (or screw) onto the front near the opening 1816 or snap onto the front. While the embodiment of FIGS. 18B and 18D show specific dimensions for the tube 1802, it should be appreciated that the size and shape may be varied without detrimentally affecting the functionality of the tube 1802.

### Third Embodiment of Dispenser (Model TT (Triangular Tube))

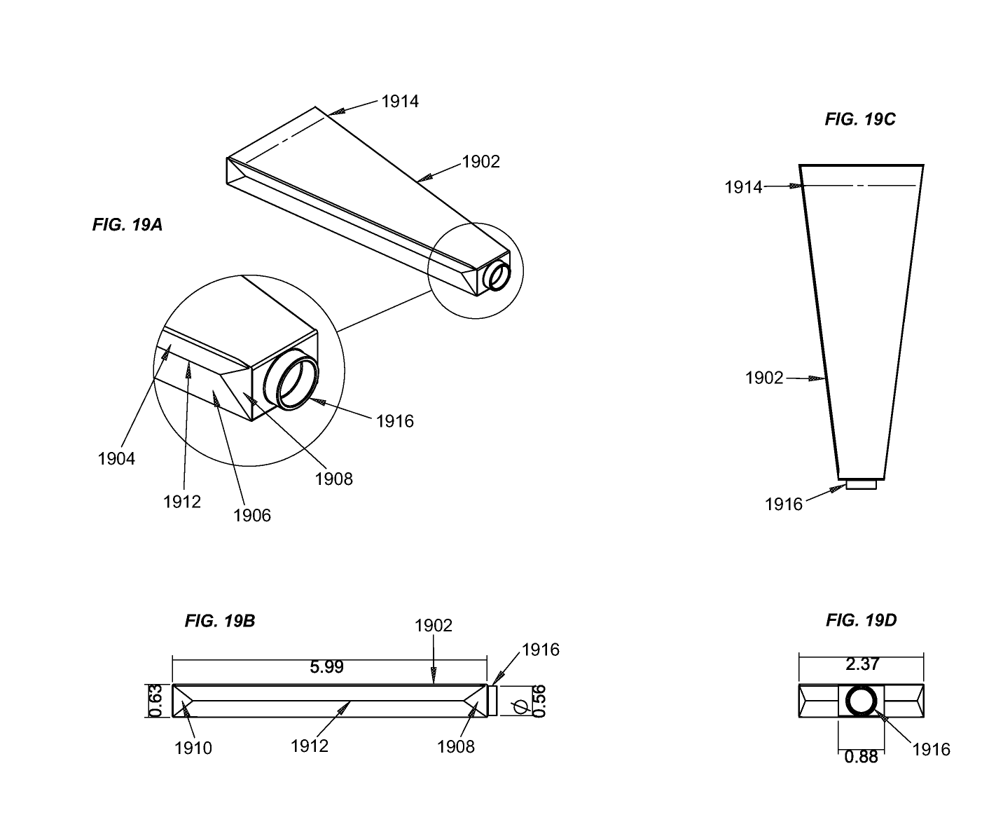

FIGS. 19A through 19D show another embodiment of a toothpaste tube 1902. For convenience, the tube 1902 of FIGS. 19A through 19D is referred to herein as a triangular tube (or Model TT) 1902.

FIG. 19A is a perspective view of the tube 1902, also showing a detailed view of an opening 1916, and various creases 1912 along the side of the tube 1902. FIG. 19B is a side view of Model TT 1902, showing facets 1908, 1910 of the tube 1902, which will facilitate folding of the tube 1902. FIG. 19C shows a top view of Model TT 1902, showing the triangular (or trapezoidal) shape of the tube 1902 and an additional crease 1914 toward the back of the tube 1902, which also facilitates substantially-flat folding of the tube 1902. FIG. 19D shows a front view of Model TT 1902, showing the opening 1916 at the front end of the tube 1902.

Similar to Model RT 1802, Model TT 1902 is configured to fold neatly flat at the end of its life cycle, much like a gift bag can fold flat. Specifically, in the embodiment of FIGS. 19A through 19D, tube 1902 has four facets 1904, 1906, 1908, 1910 on one side. Similarly, the tube 1902 has four facets (not shown) on the other side, which are configured substantially similarly as the facets 1904, 1906, 1908, 1910. The facets 1904, 1906, 1908, 1910 fold inwardly along their respective creases 1912 as toothpaste (or other viscous fluid like, for example, ointment or gel) is squeezed out of the tube 1902.

While Model TT 1902 does not taper toward the back, it can easily be configured in another embodiment to taper toward the back, similar to Model CT 1702. The opening 1916 is located at the front of the tube 1902, where the tube 1902 will connect with a base of a cap (not shown in FIGS. 19A through 19D). As will be discussed below, Model TT 1902 is compatible with several different cap models (not shown in FIGS. 19A through 19D).

Similar to Model RT 1702, it should be appreciated by one having ordinary skill in the art that the cap (not shown in FIGS. 19A through 19D) can either twist (or screw) onto the front near the opening 1916 or snap onto the front. While the embodiment of FIGS. 19B and 19D show specific dimensions for the tube 1902, it should be appreciated that the size and shape may be varied without detrimentally affecting the functionality of the tube 1902.

### Fourth Embodiment of Dispenser (Model STU (Stand-Up Tube))

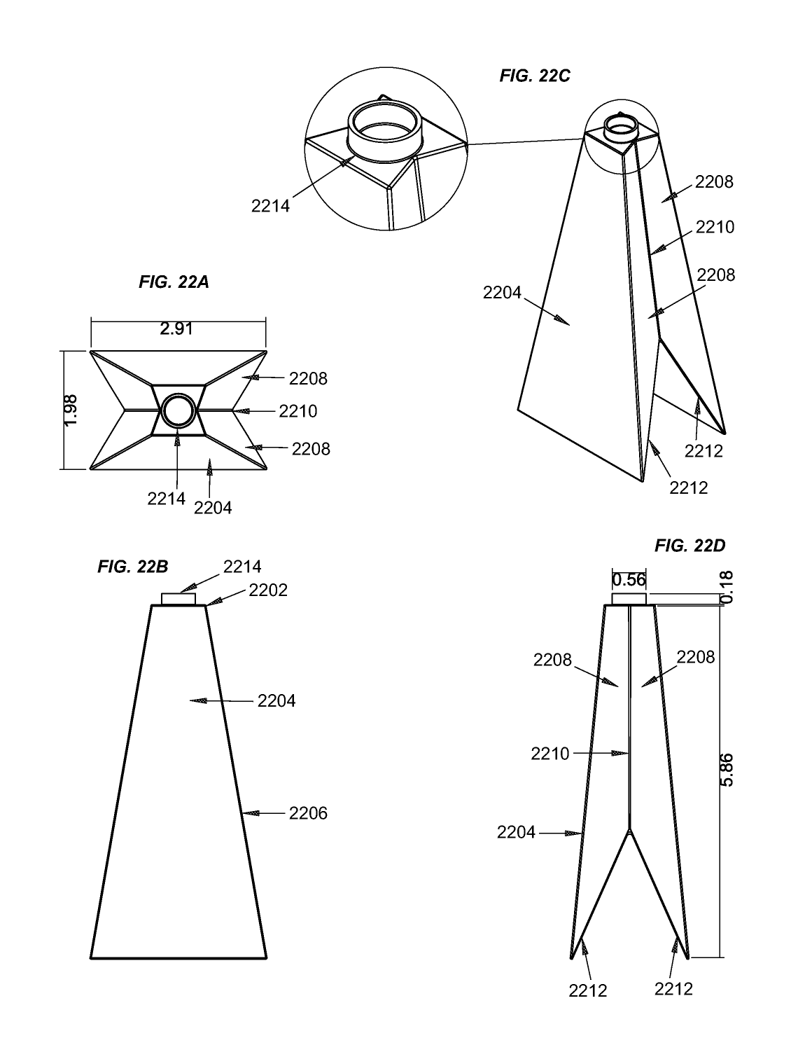

FIGS. 22A through 22D show another embodiment of a toothpaste tube 2202. For convenience, the tube 2202 of FIGS. 22A through 22D is referred to herein as a stand-up tube (or Model STU) 2202.

FIG. 22C is a perspective view of the tube 2202, also showing a detailed view (also referred to as close-up or zoom) of an opening 2214, and a crease 2210 along the side of the tube 2202. FIG. 22D is a side view of Model STU 2202, showing facets 2208 of the tube 2202, which will facilitate folding of the tube 2202. FIG. 22B shows a front view of Model STU 2202, showing a trapezoidal front face 2204 of the tube 2202. FIG. 22A shows a top view of Model STU 2202, showing the opening 2214 at the top end of the tube 2202.

Model STU 2202 stands up vertically when not in use. While FIGS. 22A through 22D show the tube 2202 standing on the bottom side (i.e., side that is opposite the opening end), it should be appreciated that the tube 2202 can also be configured to stand on the top side (i.e., side that has the opening 2214). For such embodiments, where the tube stands vertically on the cap, the size of the cap can be increased to provide stability.

On each side, Model STU 2202 has two facets 2208 that come together at a crease 2210. For some embodiments, a third facet (or more) may be included near the top of the base 2202 in a triangular shape, similar to Model STR (FIG. 28), Model RT (FIG. 18), or Model TT (FIG. 19). As shown in FIG. 22D, the facets are shaped in such a way that the tube 2202 forms handles 2212 on the front and back of the tube 2202. As the handles 2212 are pushed toward each other, the facets 2208 fold inwardly along their respective creases 2212 as toothpaste (or other viscous fluid like, for example, ointment or gel) is squeezed out of the tube 2202. For Model STU, the tube 2202 would be manufactured or constructed in such a way that, when squeezed, one would feel a slight resistance, which facilitates the recovery of the tube 2202 as it retains its original shape. For some embodiments, a hard thin plastic material, which is flexible but which also maintains its shape, is attached underneath the main fold to facilitate recovery. For other embodiments, a spring or other simple recovery mechanism can be used to facilitate recovery to its original shape. The base of the tube 2202 can be made out of a sturdier type of material, if desired.

The opening 2214 is located at the top (or bottom, depending on the configuration) of the tube 2202, where the tube 2202 will connect with a base of a cap (not shown in FIGS. 22A through 22D). As will be discussed below, Model STU 2202 is compatible with several different cap models (not shown in FIGS. 22A through 22D). However, in one preferred embodiment, Cap STU (as described below) is specifically designed such that the tapered sides fit closely to the shape of Model STU. The opening of the tube 2202 can have some sort of cover (e.g., thin foil) that is removed or peeled off after purchase and prior to the initial dispensing of toothpaste. Such a cover provides increased hygiene by providing an indication of tampering. Additionally, this permits sale of the tube 2202 without external packaging, and also prevents accidental leakage during shipping and shelving

Similar to Model RT 1702, it should be appreciated by one having ordinary skill in the art that the cap (not shown in FIGS. 22A through 22D) can either twist (or screw) onto the top (or bottom) near the opening 2214 or snap onto the front (or bottom). While the embodiment of FIGS. 22A and 22D show specific dimensions for the tube 2202, it should be appreciated that the size and shape may be varied without detrimentally affecting the functionality of the tube 2202. It should also be appreciated that the handles and the opening 2214 of the tube 2202 can vary in shape and size. Additionally, the number of creases and facets can be altered to accommodate different designs without detrimentally affecting the functionality of the tube 2202.

### Fifth Embodiment of Dispenser (Model TS (Travel Size))

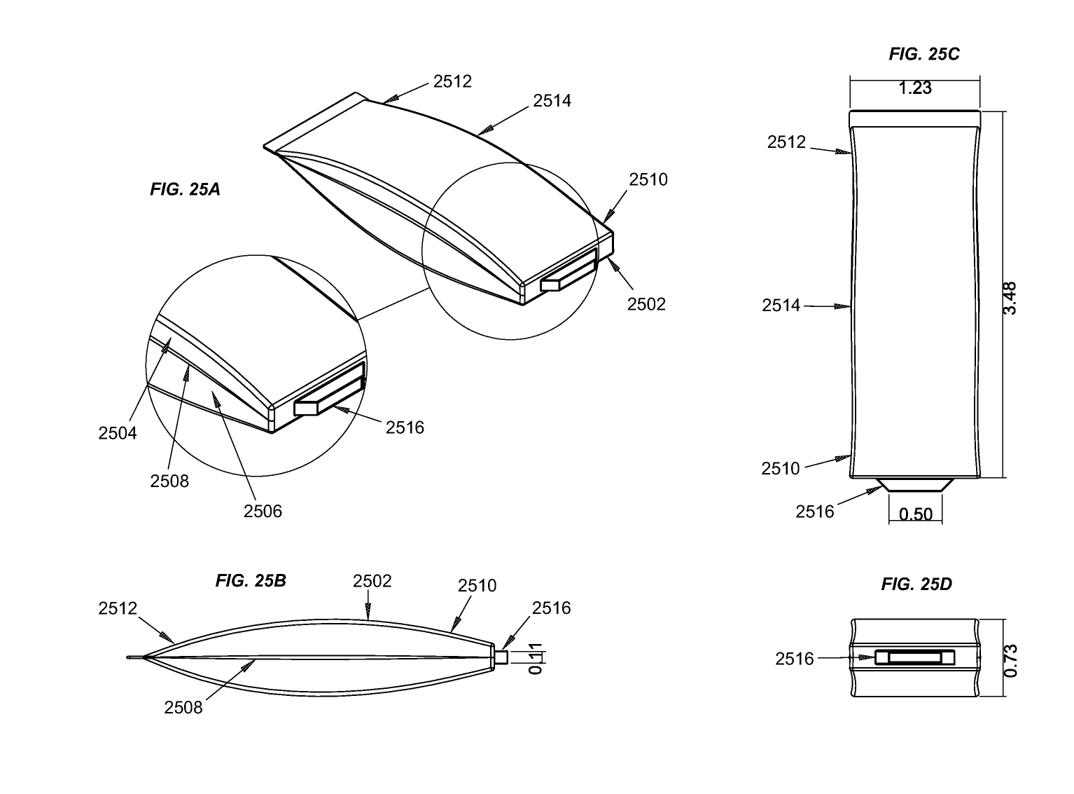

FIGS. 25A through 25D show another embodiment of a toothpaste tube 2502. For convenience, the tube 2502 of FIGS. 25A through 25D is referred to herein as a travel-size tube (or Model TS) 2502. It should be appreciated that all of the models shown herein can be configured as travel-size tubes by simply adjusting the dimensions of the tube. However, for the sake of identification, this particular model is referred to herein as Model TS 2502.

FIG. 25A is a perspective view of the tube 2502, also showing a detailed view of an opening 2516, and a crease 2508 and facets 2504, 2506 along the side of the tube 2502. FIG. 25B is a side view of Model TS 2502, showing facets 2504, 2506 of the tube 2502, which, along with the crease 2508, will facilitate folding of the tube 2502. FIG. 25C shows a top view of Model TS 2502, showing the shape of the tube 2502. FIG. 25D shows a front view of Model TS 2502, showing the opening 2516 at the front end of the tube 2502.

Model TS 2502 is also configured to fold neatly flat at the end of its life cycle. Specifically, in the embodiment of FIGS. 25A through 25D, tube 2502 has two facets 2504, 2506 on each side of the tube, and a crease 2508 which, along with the facets 2504, 2506, facilitates inward folding of the tube 2502 as toothpaste (or other viscous fluid like, for example, ointment or gel) is squeezed out of the tube 2502.

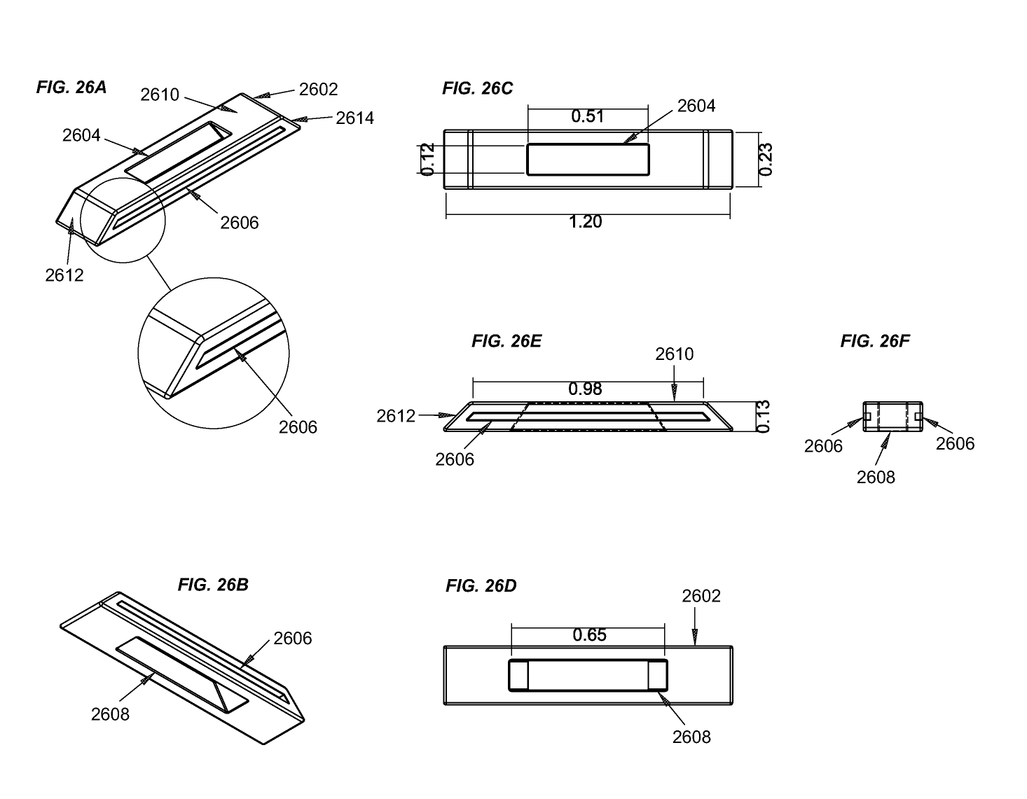

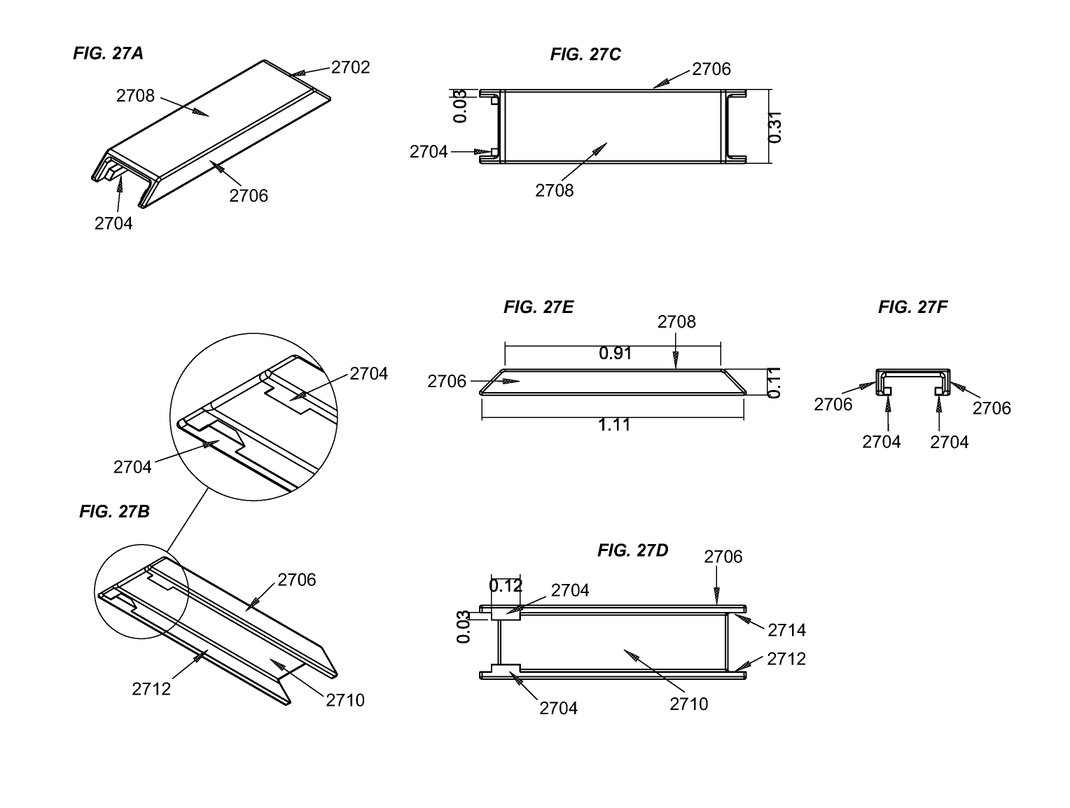

The opening 2516 is located at the front of the tube 2502, where the tube 2502 will connect with a base of a cap (not shown in FIGS. 25A through 25D). As will be discussed below, Model TS 2502 is compatible with the cap shown in FIGS. 26A through 26F and 27A through 27F, or other similarly-designed caps (not shown). The cap (FIGS. 26A through 26F and 27A through 27F) can snap onto the front end of the tube 2502. For some embodiments, the cap can partially twist on and then snap on securely. For other embodiments, the cap can twist onto the front end.

Conventional travel-size tubes tend to crumple up and cause user frustration, and their small sizes only compound the frustration. Additionally, for conventional tubes with twist-off caps, the cap can be separated from the tube itself, and be easily lost or misplaced. This embodiment of Model TS 2502 overcomes those problems.

While the embodiment of FIGS. 25B, 25C, and 25D show specific dimensions for the tube 2502, it should be appreciated that the size and shape may be varied without detrimentally affecting the functionality of the tube 2502.

### Sixth Embodiment of Dispenser (Model STR (Straight Tube))

FIGS. 28A through 28D show one embodiment of a toothpaste tube 2802. For convenience, the tube 2802 of FIGS. 28A through 28D is referred to herein as a straight tube (or Model STR) 2802.

FIG. 28A is a perspective view of the tube 2802, also showing a detailed view of an opening 2814, and a crease 2810 along the side of the tube 2802. FIG. 28B is a side view of Model STR 2802, showing the tube 2802 tapering toward the back 2812 of the tube 2802. FIG. 28B also shows facets 2804, 2806 disposed on either side of the crease 2810, along with a triangular facet 2808 disposed toward the opening 2814 of the tube, which, in combination, facilitate folding of the tube 2802. FIG. 28C shows a top view of Model STR 2802, showing straight sides of the tube 2802. FIG. 28D shows a front view of Model STR 2802, showing the opening 2814 at the front end of the tube 2802.

Model STR 2802 is configured to fold neatly flat at the end of use. The facets 2804, 2806 on both sides fold inwardly along their respective creases 2808 as toothpaste (or other viscous fluid like, for example, ointment or gel) is squeezed out of the tube 2802.

The opening 2818 is located at the front of the tube 2802, where the tube 2802 will connect with a base of a cap (not shown in FIGS. 28A through 28D). As will be discussed below, Model STR 2802 is compatible with several different cap models (not shown in FIGS. 28A through 28D).

While not shown in great detail, it should be appreciated by one having ordinary skill in the art that the cap (not shown in FIGS. 28A through 28D) can either twist (or screw) onto the front near the opening 2814 or snap onto the front. Also, it should be appreciated that the sides of the tube 2802 can include more facets and more creases without altering the advantageous features of the tube 2802. While specific dimensions are shown in FIG. 28B, it should be appreciated that these dimensions are shown only for illustrative purposes, and are not intended to be limiting on the invention.

### First Embodiment of Cap (Cap A)

Various embodiments of the invention also include caps having slidable lids.

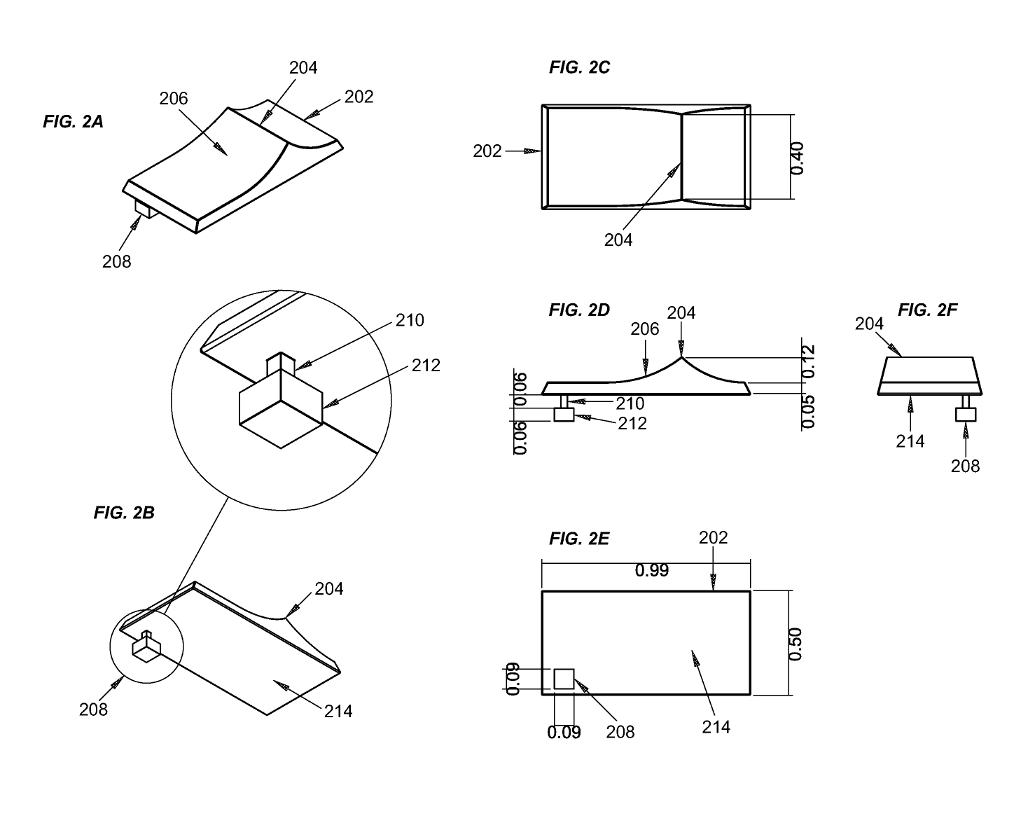

FIGS. 1A through 1G show one embodiment of a base 102 of a cap for a toothpaste tube. This base 102 is compatible with Models CT 1702, RT 1802, TT 1902, and STU 2202. FIGS. 2A through 2F shows one embodiment of a lid 202 that couples with the base 102 shown in FIGS. 1A through 1G. For clarity, this embodiment of the cap is referred to herein as Cap A.

The cap comprises a base 102 and a lid 202. The base 102 of the cap houses an opening 112 for expelling the toothpaste. Additionally, in this embodiment, one end of the cap comprises a track 104 that couples the base 102 to the lid 202. On the other end, the cap comprises a circular opening 110 that couples the base 102 to a toothpaste tube. The lid 202 comprises a peg 208 that couples to the track 104 in the base 102, thereby permitting the lid 202 to slide with reference to the base 102. This slidable coupling of the base 102 and the lid 202 permit opening and closing of the cap. For Cap A, the track 104 is created by cutting a narrow slit into the top surface 114 of the base 102 of the cap.

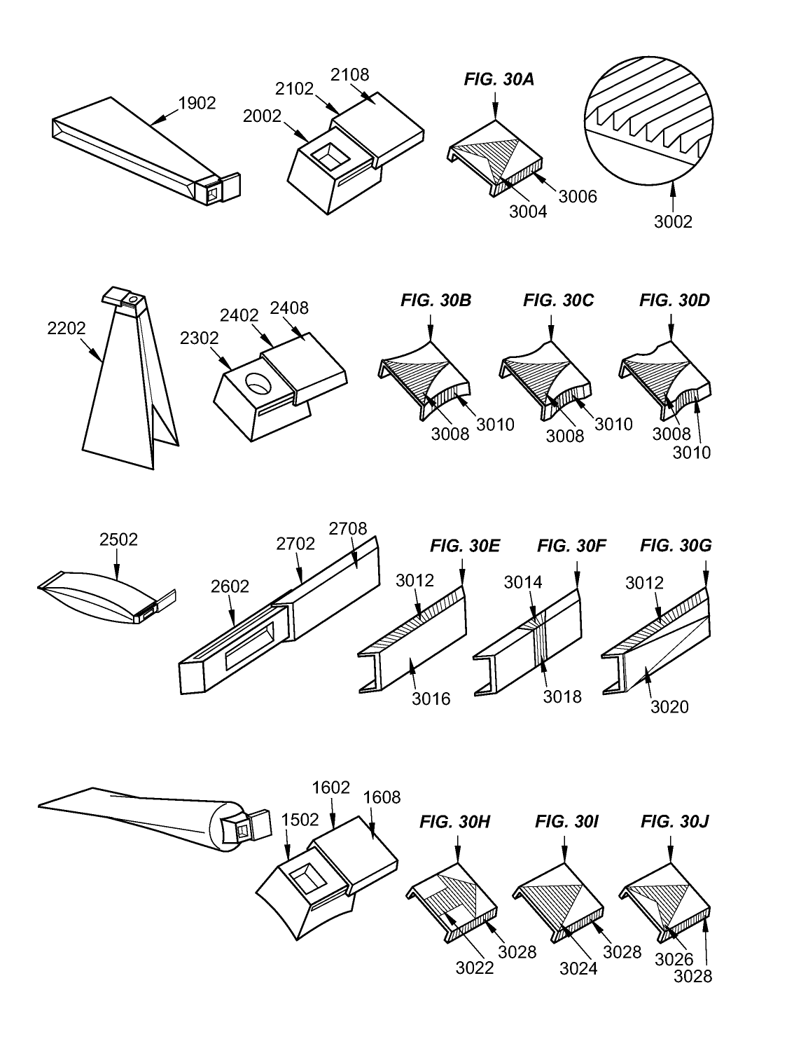

For some embodiments, a stump 204 can be provided on the lid 202 for the thumb or fingers to grasp, thereby facilitating the opening and closing of the lid 202 by a user. It should be appreciated that the lid 202 need not include the stump 204, but may, for other embodiments, be flat. The lid 202 can also have a grip (see FIG. 30) on the surface 206, thereby increasing traction during both wet and dry conditions and facilitating the opening and closing of the lid 202.

The peg 208 of the lid 202 in Cap A initially slides transversely into the track 104 of base 102. Thereafter, the peg 208 on the lid 202 slides longitudinally on the track 104 to open and close the cap. For some embodiments, the peg 208 engages the track 104 in such a way as to prevent the lid 202 from completely sliding off of the base 102 during day-to-day use. The lid 202 can also be removed from the base 102 for cleaning or maintenance if necessary.

In some embodiments, the peg 208 comprises a stem 210 and a knob 212. The stem 210 attaches to the lid 214, while the knob 212 slides into the track 104. For the embodiment of FIG. 2, the knob 212 is roughly three times wider and thicker than the stem 210. As such, the knob 212 secures the lid 204 to the base 102 during normal operation.

There are two levels for the track 104. The upper level 106, closer to the upper surface of the base 102, is narrower and allows the stem 210 of the peg to fit into the upper level 106. The lower level 108, just below the upper level 106 and deeper underneath the surface of the base 102, houses the knob of the peg 212.

As noted above, unlike twist-off lids, which can easily be separated from the base of the cap and become lost or misplaced, the sliding-lid design of Cap A keeps the lid 202 coupled to the base 102 during day-to-day operation, thereby reducing the likelihood of losing the lid 202. Additionally, unlike conventional twist-off lids, which often require two-handed operation, the sliding-lid design permits one-handed operation.

For other embodiments, it should be appreciated that the lid 202 can slide diagonally at an angle, slight or prominent, along a curvature, or pivotally. The curvature could also be at an angle diagonally. Here, curvature refers to a curve similar to a largely filleted corner or edge. Moreover, it should be appreciated that the front 112 and back 110 openings of the cap can vary in shape in size as well. It can be circular, oval-shaped, square, other polygonal shape, or other organic shapes. While FIG. 1 shows the sides 116 of the base 102 being tapered, it should be appreciated that the sides 116 can be straight (or parallel), can vary in shape and size, and can be more rounded-off on the edges 118.

### Second Embodiment of Cap (Cap B)

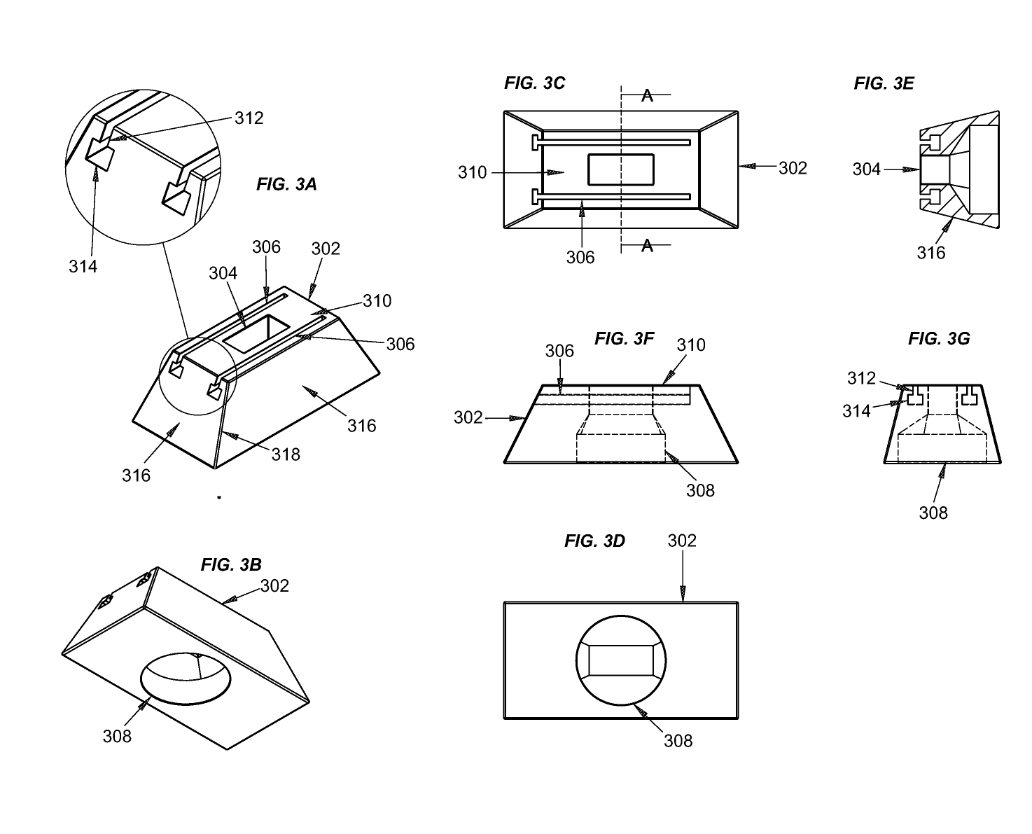

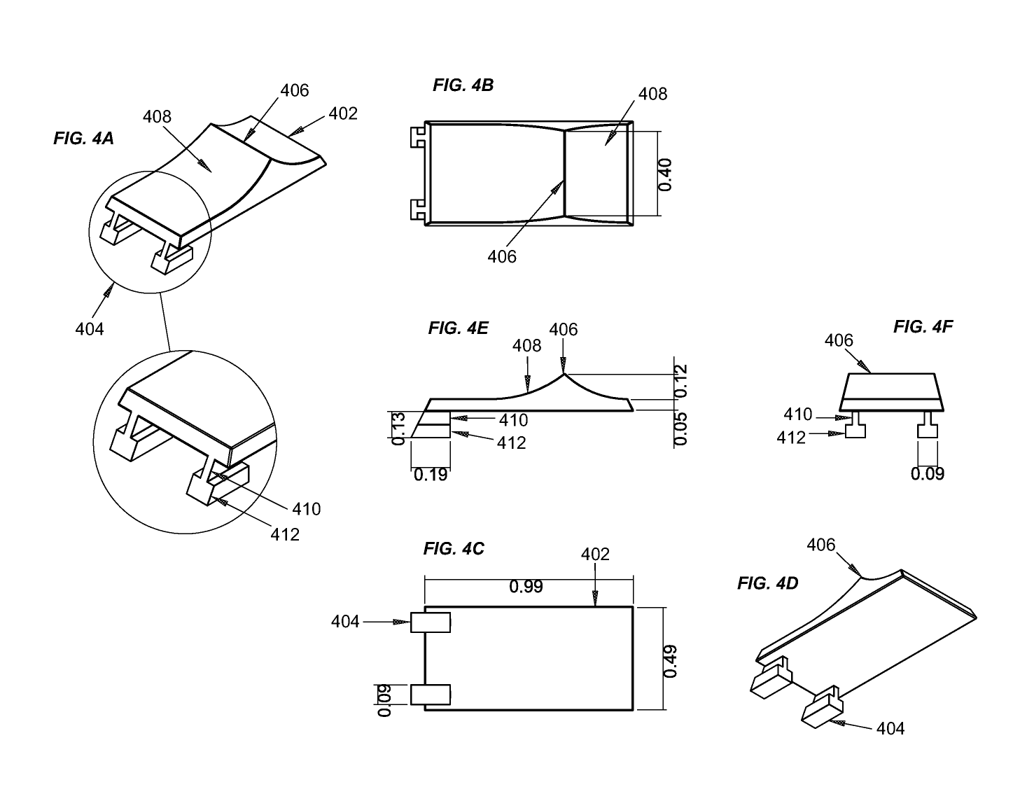

FIGS. 3A through 3G show another embodiment of a base 302 of a cap for a toothpaste tube. This base 302 is compatible with Models CT 1702, RT 1802, TT 1902, and STU 2202. FIGS. 4A through 4F show one embodiment of a lid 402 that couples with the base 302 shown in FIGS. 3A through 3G. For the sake of clarity, this embodiment of the cap is referred to herein as Cap B.

The cap comprises a base 302 and a lid 402. The base 302 houses a top opening 304 for expelling the toothpaste, tracks 306 that couple the base 302 to the lid 402, and, on the bottom, a circular opening 308 that couples the cap to the [to the] toothpaste tube. In this embodiment, the lid 302 comprises two separate pegs 404 that are inserted into the two separate tracks 306 of the base 302. The coupling of the pegs 404 to the tracks 306 permits the lid 402 to slide open and closed with reference to the base 302. The sliding lid 402 is slid open by a stump 406 that facilitates grasping by the thumb or fingers. It should be appreciated that the lid 402 need not have the stump 406, but, alternatively, may be flat. The lid 402 may also include a grip 408, instead of being smooth, to increase traction while opening and closing during wet or dry conditions.

The pegs 404 of the lid 402 slide longitudinally on the two tracks 306 of the base 302 to open and close the lid 402. For this particular embodiment, there are two pegs 404 on the lid 402. Each peg 404 comprises a stem 410 and knob 412. The stems 410 are attached to the bottom of the lid 402. For Cap B, the knobs 412 are roughly three times wider and thicker than the stems 410. The pegs 404 are shaped to fit the contours of the base 302, specifically the slant on the back of the base 302. As such, when the lid 402 is closed, the pegs 404 are flush against the base 302 of the cap giving the appearance of one whole unit. Also, when the lid 402 is open all the way, the lid 402 will stop because the tracks stop before the end of the edge of the base 302.

The tracks 306 are created by cutting narrow slits into the top surface 310 of the base 302. The pegs 404 slide along the tracks 306. There are two levels for the two slits 306. The upper levels 312, closer to the surface 310 of the base 302, are narrower and only allow the stems 410 of the pegs 404 to fit here. The lower levels 314, just below the upper levels 312 and deeper underneath the surface 310 of the base 302, house only the bases of the pegs 404. In some embodiments, an obstruction, or something that prevents the lid 402 from falling off the base when you close it all the way, can be implemented.

### Third Embodiment of Cap (Cap C)

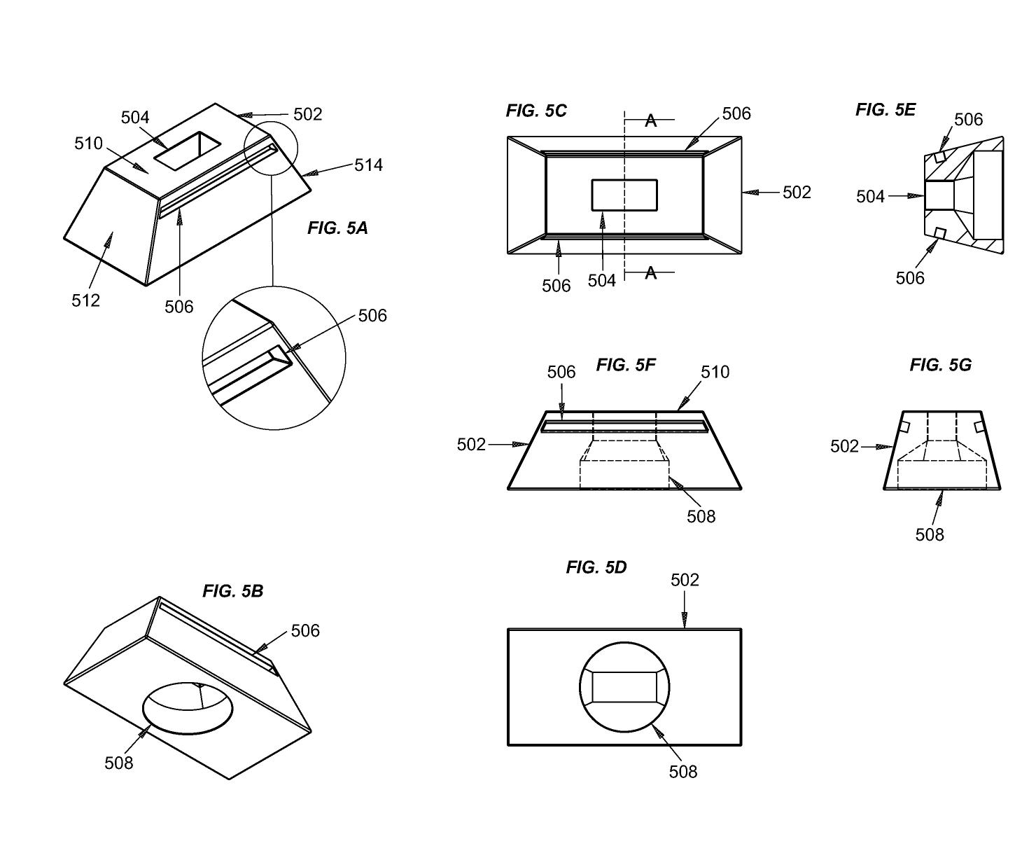

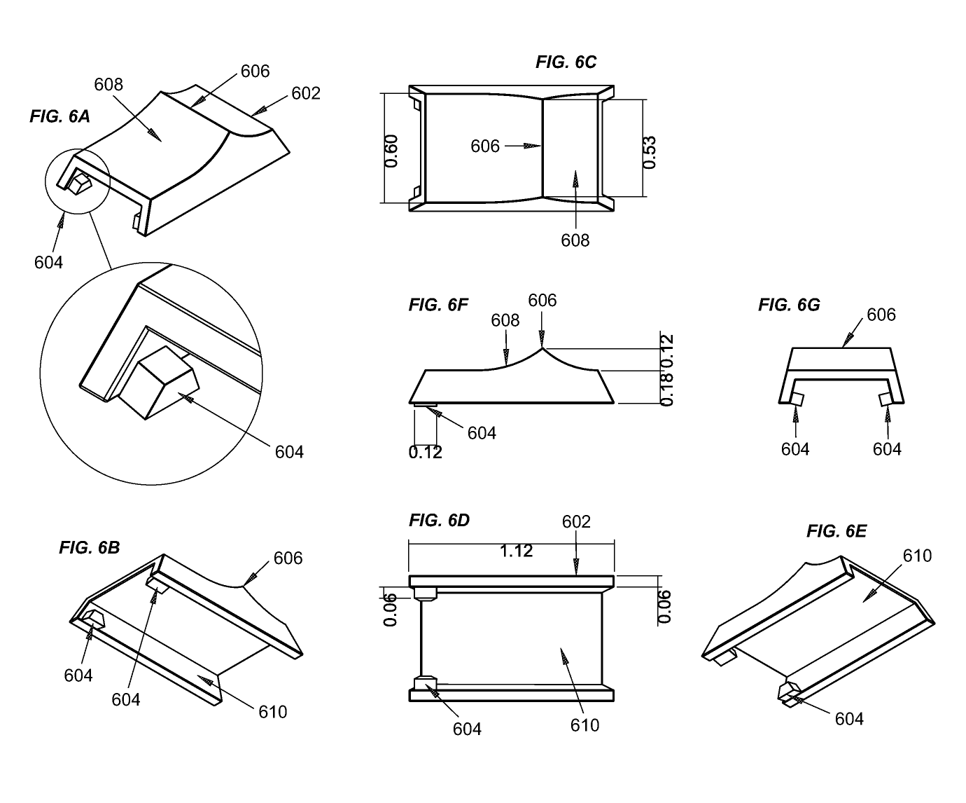

FIGS. 5A through 5G show a third embodiment of a base 502 of a cap for a toothpaste tube. This base 502 is compatible with Models CT 1702, RT 1802, TT 1902, and STU 2202. FIGS. 6A through 6G show one embodiment of a lid 602 that couples to the base 502 shown in FIGS. 5A through 5G. For the sake of clarity, this embodiment of the cap is referred to herein as Cap C.

Cap C comprises a base 502 and a lid 602. The base 502 houses the top opening 504 for the toothpaste to come out of, tracks 506 that connects the base 502 to the lid, and on the bottom a circular opening 508 that connects to the toothpaste tube.

Unlike Cap B, which has the tracks 306 on the top of the base 302, Cap C has a base 502 having tracks 506 that are cut into the side of the base 502. As such, the corresponding pegs 604 on lid 602 extend inwardly from the lid 602, as shown in the profile of FIG. 6G.

Once engaged, the lid 602 slides longitudinally with reference to the base 502 to open and close. The pegs 604, which engage the tracks 506, allow the lid 602 to remain engaged with the base 502 during normal operation. As shown in FIG. 6F, the lid may, but need not, include a stump 606, which facilitates gripping of the lid 602 during operation.

Since the operation of Cap C can be discerned by one having skill in the art from the drawings in FIGS. 5 and 6, and also from the description of other embodiments, as provided above, additional details with reference to Cap C are omitted herein.

### Fourth Embodiment of Cap (Cap D)

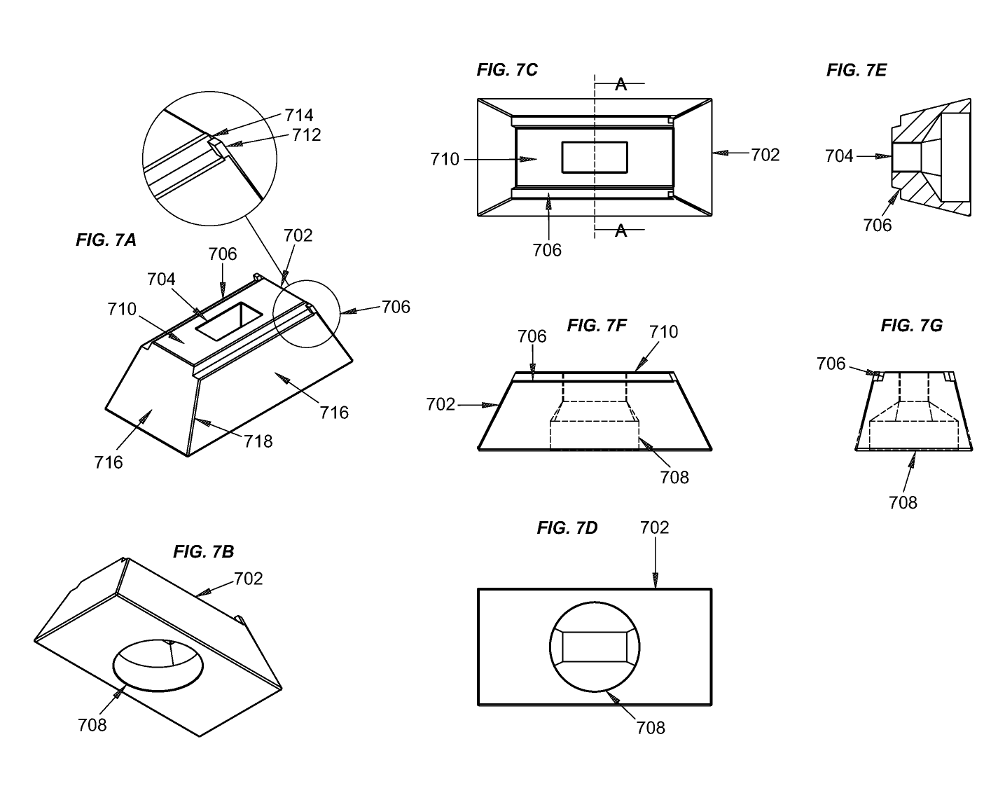

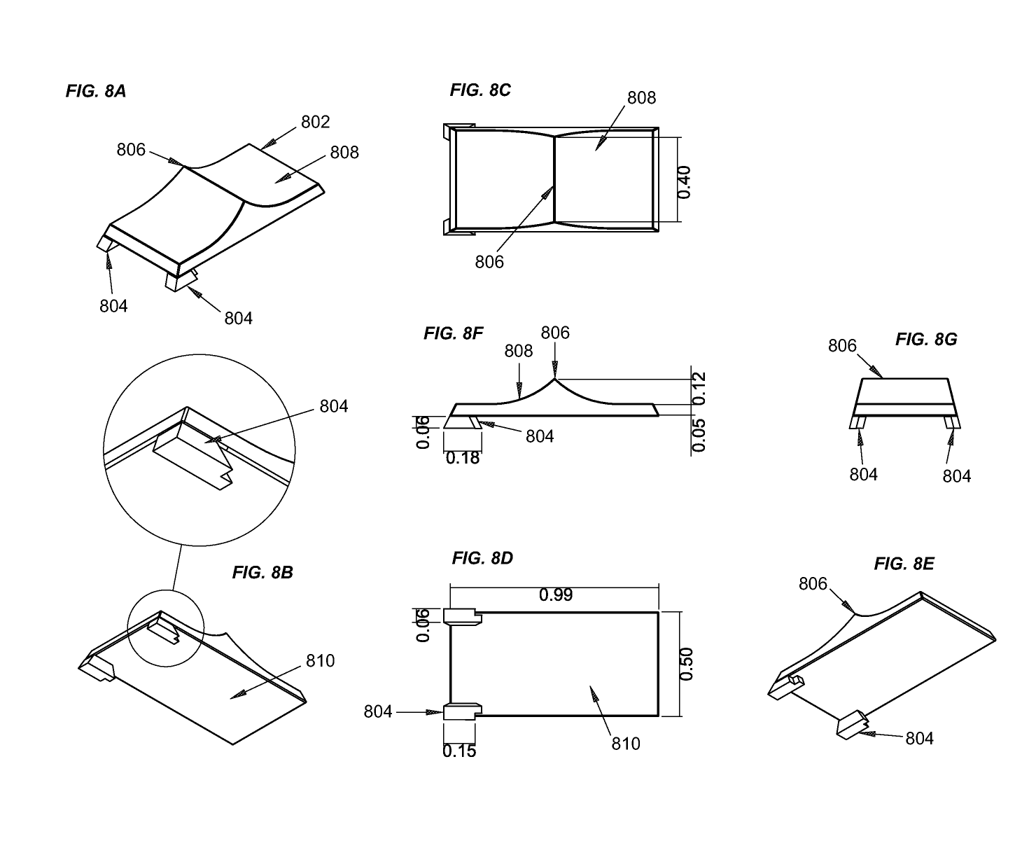

FIGS. 7A through 7G show a fourth embodiment of a base 702 of a cap for a toothpaste tube. This base 702 is compatible with Models CT 1702, RT 1802, TT 1902, and STU 2202. FIGS. 8A through 8G show one embodiment of a lid 802 that couples to the base 702 shown in FIGS. 7A through 7G. For the sake of clarity, this embodiment of the cap is referred to herein as Cap D.

The embodiment of Cap D differs from the embodiments of Cap B and Cap C insofar as the tracks 706 on the base 702 and the pegs 804 on the lid 802 are configured differently. Specifically, the pegs 804 are L-shaped, thereby allowing them to fit into the tracks 706 of the base 702 securely. The pegs 804 are shaped to fit the contours of the base 702, specifically the slant on the left side of the base 702. Thus, when the lid 802 is closed, the pegs 804 are flush against the base 702 of the cap giving the appearance of one whole unit. This does two things. First, it stops the lid 802 from sliding off the base 702 when opening, and, second, it holds the lid 802 securely in place and prevents it from falling off the base 702 in other ways when opened.

In the embodiment of Cap D, the tracks 706 are created by cutting a section of the corners from the top and bottom edges of the front surface 710 of the base 702 of the cap. The two pegs 804 that are attached to the bottom 810 of the lid slide along the tracks 706. The tracks 706 stop just before the edges 712 and 714 of the base 702 of the cap. This is to prevent the lid 802 from sliding off the base 702 completely whilst opening.

For other embodiments, the tracks 706 or base 702 can have some sort of rail on which the pegs 804 can ride. This will couple the lid 802 more securely to the base 702. The tracks 706 can have some sort of bump, or any type of mechanism or obstruction, to stop the pegs 804 from sliding off the base 702 completely when closing. This bump can vary in size and shape. For yet other embodiments, the top and bottom edges of the lid 802 can extend to cover over the tracks 706. Additionally, in other variations, the pegs 804 can attach to the insides of these new coverings in addition to being attached to the back of the lid 802, thereby covering up the tracks 706 and perhaps helping the lid 802 to stay on more securely.

### Fifth Embodiment of Cap (Cap E)

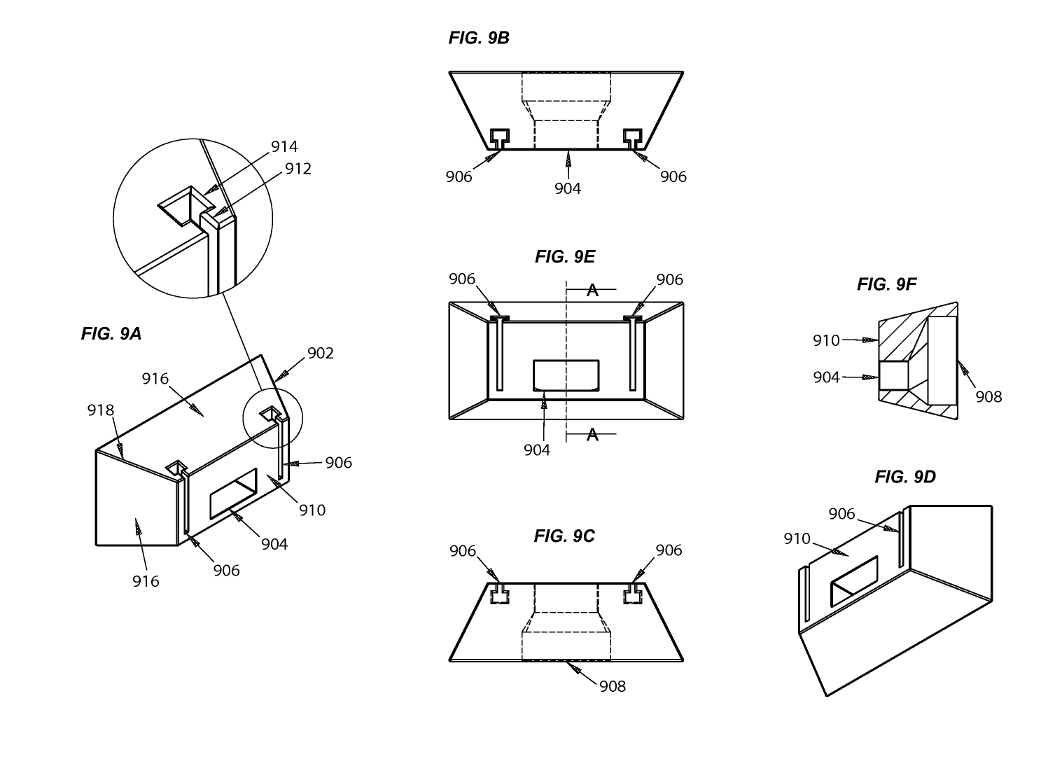

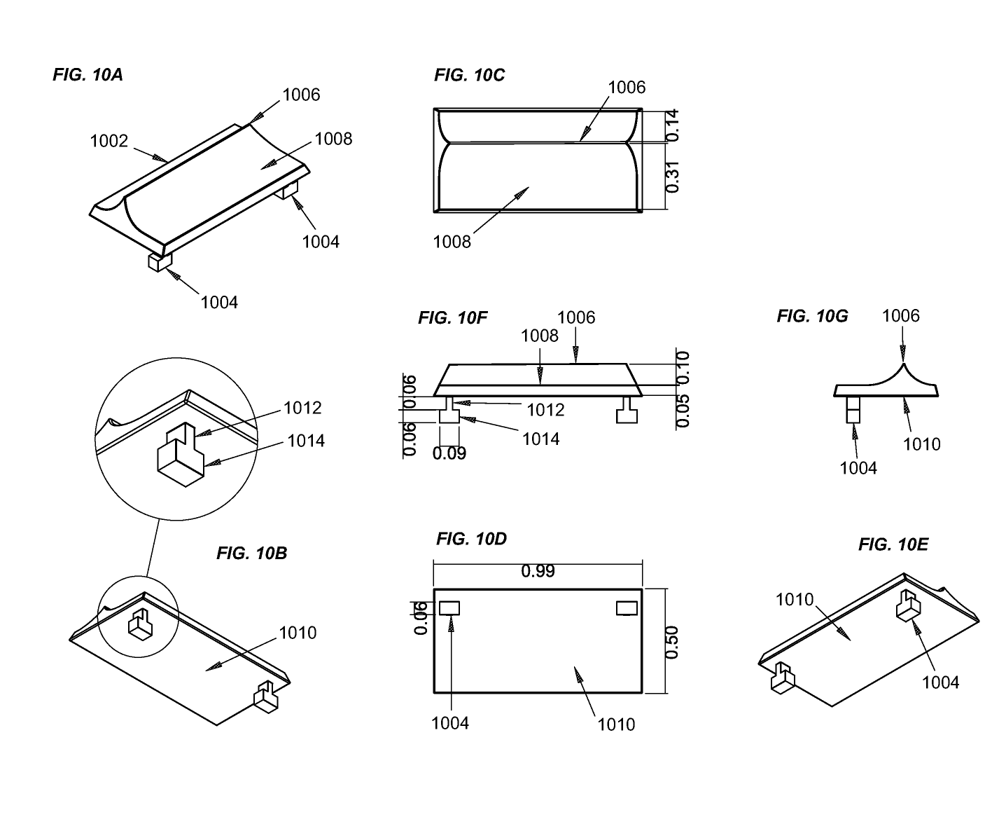

FIGS. 9A through 9F show a fifth embodiment of a base 902 of a cap for a toothpaste tube. This base 902 is compatible with Models CT 1702, RT 1802, TT 1902, and STU 2202. FIGS. 10A through 10G show one embodiment of a lid 1002 that couples to the base 902 shown in FIGS. 9A through 9F. For the sake of clarity, this embodiment of the cap is referred to herein as Cap E.

Cap E is similar to Cap B in appearance and function. However, unlike Cap B, which opens and closes by sliding longitudinally, Cap E opens and closes transversely. Since the distance traveled by the lid 1002 of Cap E is smaller than the distance traveled by the lid 302 of Cap B, the hole 904 is configured differently to accommodate the sliding action of the lid 302. One advantage of Cap E over Cap B is that the tracks 906 are spaced wider apart, thereby providing greater stability due to a somewhat larger footprint of the contact points, namely, the portion where the tracks 906 couple to the pegs 1004.

Since the track and peg configurations are described in detail above, with reference to Caps A, B, C, and D, further discussion of track and peg configurations for Cap E is omitted herein. However, it should be appreciated that, given the description of Caps A through D, it should be appreciated that corresponding variations can be made to Cap F without detrimentally affecting the performance of Cap F.

### Sixth Embodiment of Cap (Cap F)

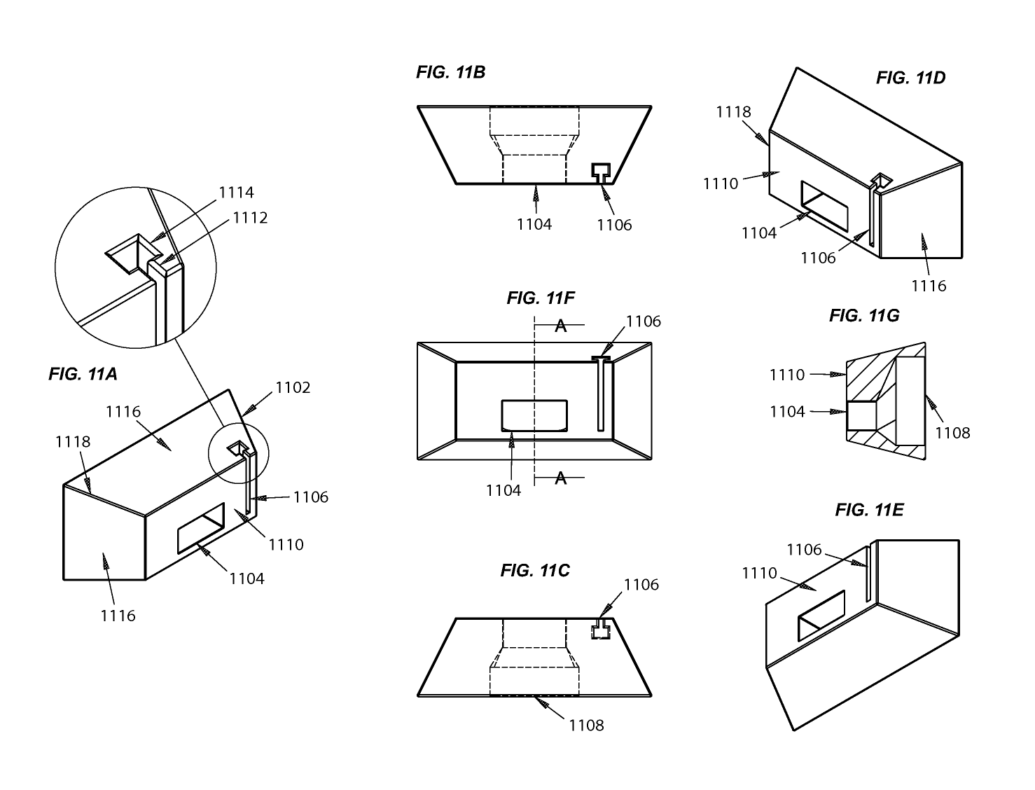

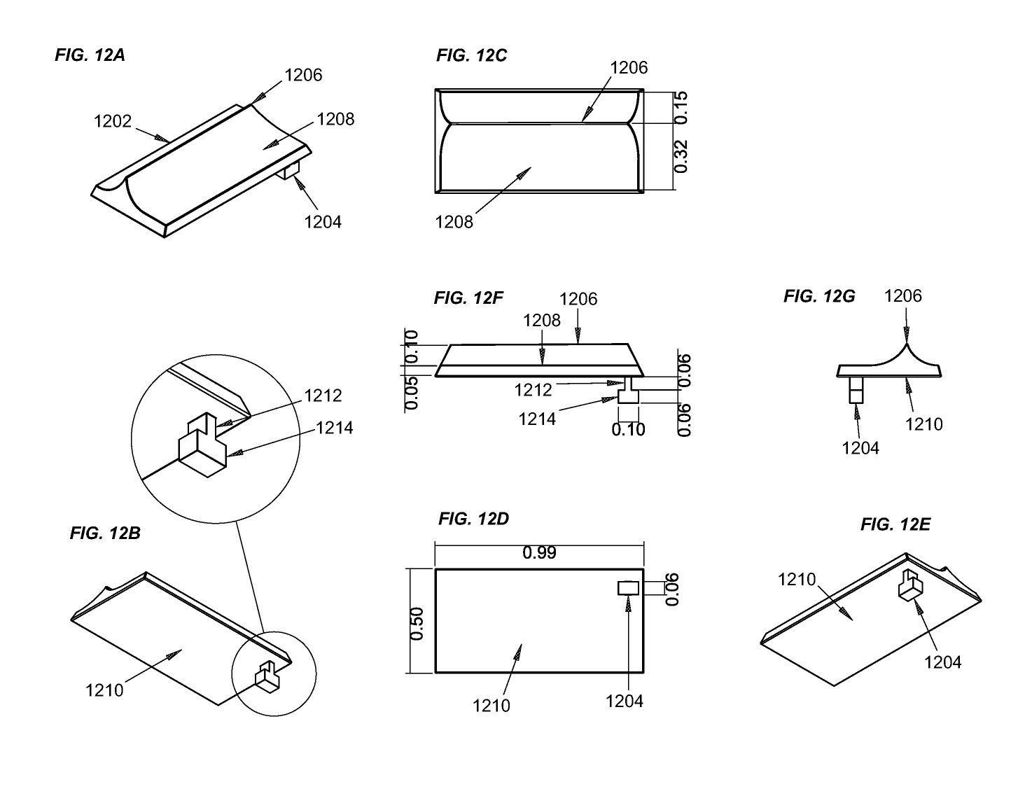

FIGS. 11A through 11G show a sixth embodiment of a base 1102 of a cap for a toothpaste tube. This base 1102 is compatible with Models CT 1702, RT 1802, TT 1902, and STU 2202. FIGS. 12A through 12G show one embodiment of a lid 1202 that couples to the base 1102 shown in FIGS. 11A through 11G. For the sake of clarity, this embodiment of the cap is referred to herein as Cap F.

Cap F, in FIGS. 11A through 11G and 12A through 12G, is a single-tracked version of Cap E, which is shown in FIGS. 9A through 9F and 10A through 10G. Thus, rather than having two tracks 906 that are substantially symmetrically disposed on either side of the hole 904 as in Cap E, the single track 1106 of Cap F is located on one side of the hole 1104. Correspondingly, the lid 1202 of Cap F has a single peg 1204, with a stem 1212 and a knob 1214, which slidably engages the track 1106. Similar to Cap E, Cap F is designed to open and close when the lid 1202 slides transversely with reference to the base 1102.

Given the description of Caps A through E, it should be appreciated that corresponding variations can be made to Cap F without detrimentally affecting the performance of Cap F.

### Seventh Embodiment of Cap (Cap G)

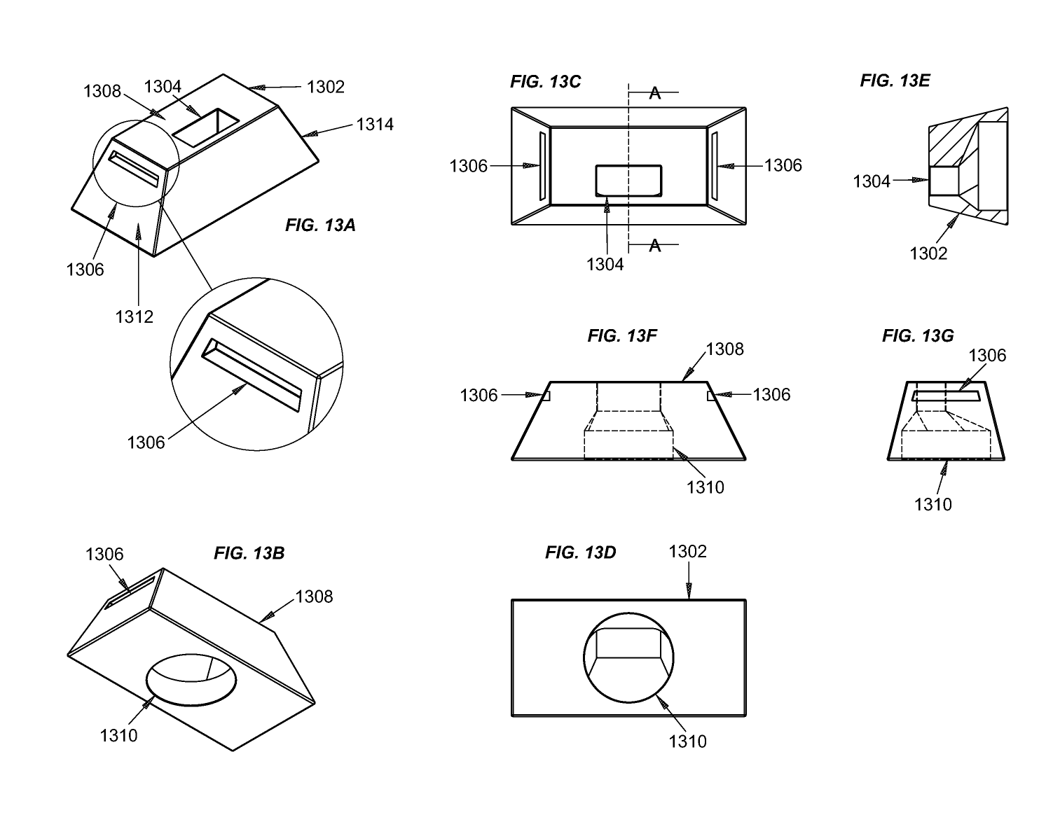

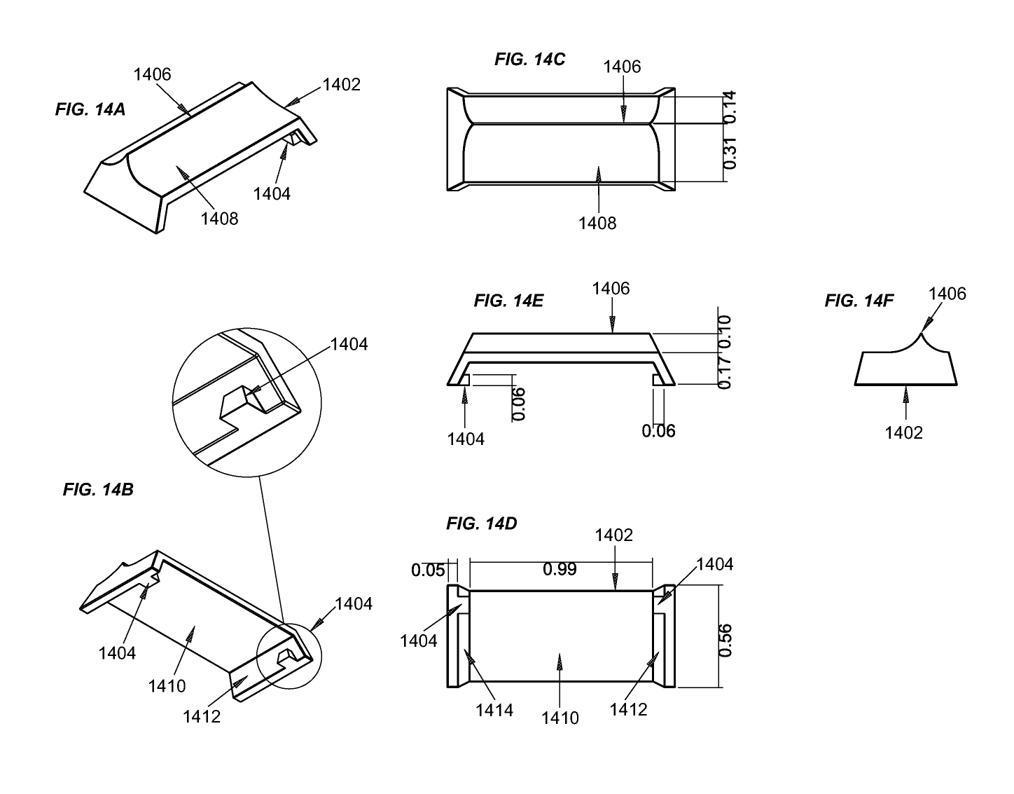

FIGS. 13A through 13G show a seventh embodiment of a base 1302 of a cap for a toothpaste tube. This base 1302 is compatible with Models CT 1702, RT 1802, TT 1902, and STU 2202. FIGS. 14A through 14F show one embodiment of a lid 1402 that couples to the base 1302 shown in FIGS. 13A through 13G. For the sake of clarity, this embodiment of the cap is referred to herein as Cap G.

Cap G is the transversely sliding version of Cap C. In other words, while the lid 602 of Cap C slid longitudinally with reference to the base 502, the lid 1402 of Cap G slides transversely with reference to the base 1302. As such, the tracks 1306 of Cap C are configured parallel to the minor axis of the cap, rather than parallel to the major axis of the cap. Since the detailed description on the operation of Cap C is sufficient to teach one having skill in the art of how Cap G would also operate, the description of Cap G is truncated here. However, it should be realized by one having skill in the art that Cap G may be modified, similar to how Caps A through F are modified, to create different embodiments without substantially affecting the performance of Cap G.

### Eight Embodiment of Cap (Cap S)

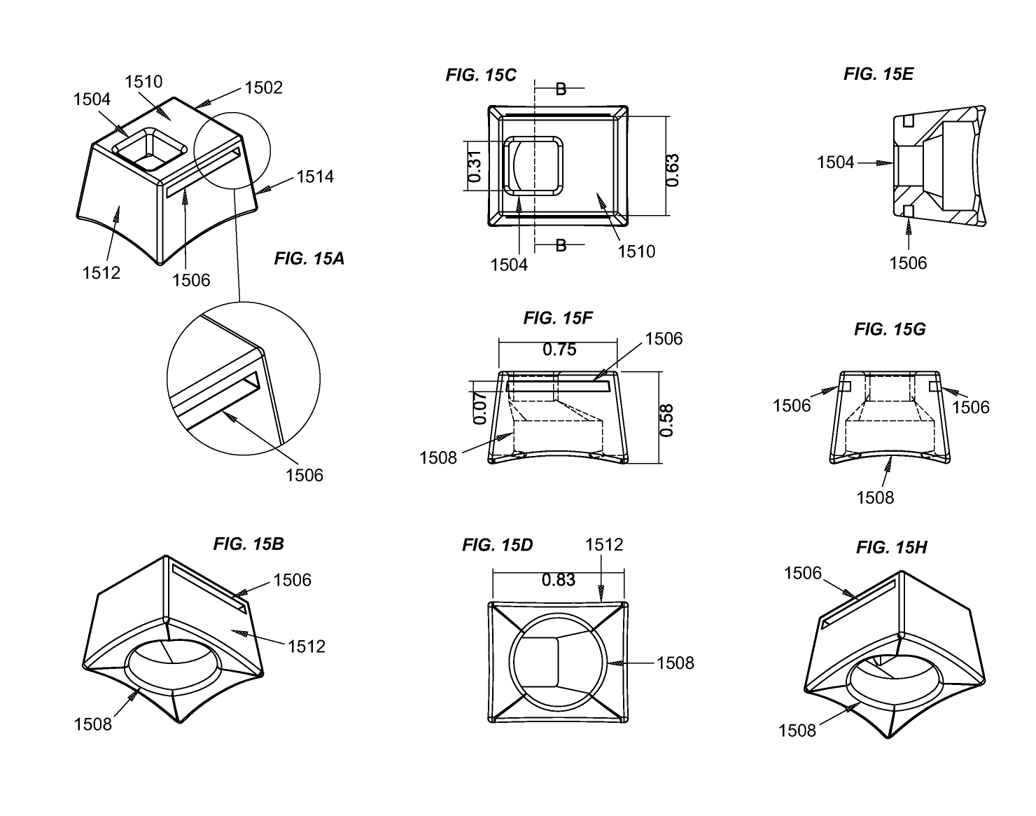

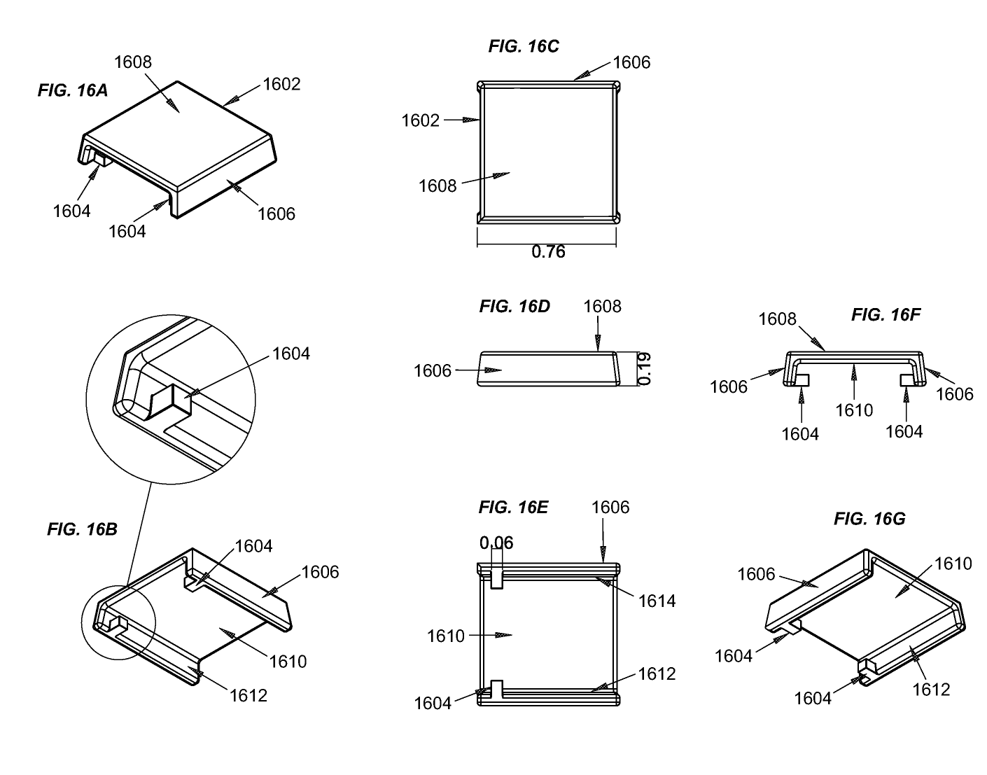

FIGS. 15A through 15H show an eighth embodiment of a base 1502 of a cap for a toothpaste tube. This base 1502 is compatible with Models CT 1702, RT 1802, TT 1902, and STU 2202. FIGS. 16A through 16G show one embodiment of a lid 1602 that couples to the base 1502 shown in FIGS. 15A through 15H. For the sake of clarity, this embodiment of the cap is referred to herein as Cap S.

Cap S comprises a base 1502 and a lid 1602. The base 1502 houses the top opening 1504 for expelling the toothpaste from the tube, tracks 1506 that couple the base 1502 to the lid 1602 such that the lid 1602 slides with reference to the base, and a circular bottom opening 1508 that couples the cap to the toothpaste tube. The tracks 1506 do not extend the full length of the base 1502. As such, as the lid 1602 slides longitudinally with reference to the base 1502, the pegs 1604, which are inserted into the tracks 1506, will naturally stop when they come to the end of the tracks 1506. In other words, for Cap S, the tracks 1506 stop just before the side edges of the base 1502, thereby preventing the lid 1602 from sliding off the base 1502 completely whilst opening and closing.

The lid 1602 is configured to extend downward on either side of the base 1502, such that a portion of the lid 1602 covers the tracks 1506. These extensions 1606 can include grips, such as those shown in FIG. 30. Each peg 1604 is a piece that is attached to the inward portion of the extensions 1606 of the lid 1610, as shown in FIG. 16B.

The lid 1602 is attached to the base 1502 by putting the pegs 1604 into their appropriate tracks 1506. Because the lid 1602 is made of flexible thin, but sturdy plastic, this allows the pegs 1604 to be pushed into their tracks 1506. Once the pegs 1604 are in place, the lid 1602 should be flush against the top surface 1510 of the base 1502.

It should be appreciated, in comparing Cap S to Cap C or Cap G, that the opening can be substantially centered on the base or, for other embodiments, located off-center on the base.

### Ninth Embodiment of Cap (Cap TT)

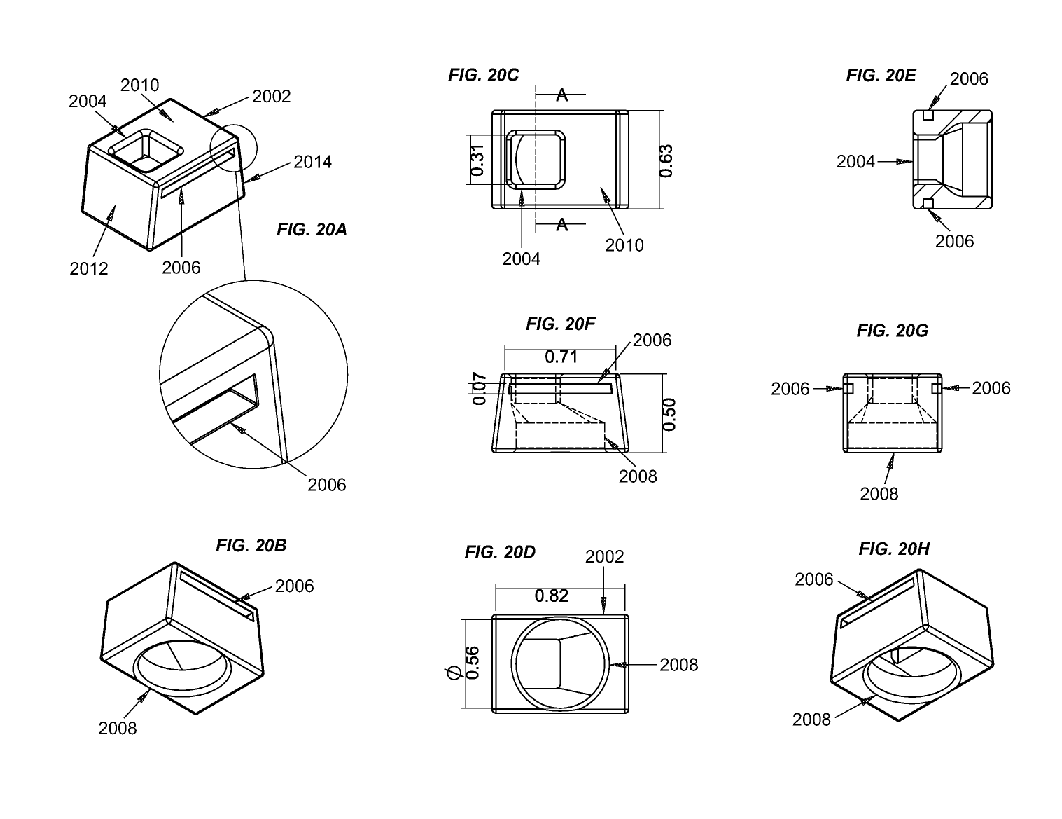

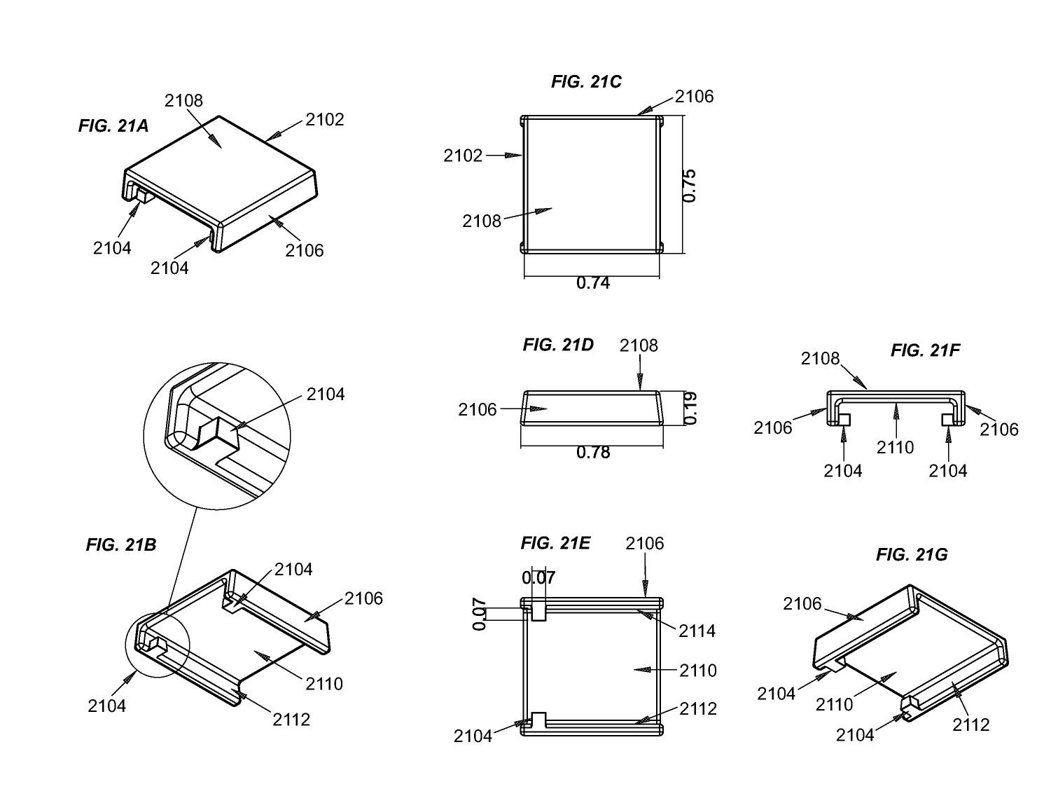

FIGS. 20A through 20H show a ninth embodiment of a base 2002 of a cap for a toothpaste tube. This base 2002 is compatible with Models CT 1702, RT 1802, TT 1902, and STU 2202. FIGS. 21A through 21G show one embodiment of a lid 2102 that couples to the base 2002 shown in FIGS. 20A through 20H. For the sake of clarity, this embodiment of the cap is referred to herein as Cap TT.

The dimensions of Cap TT are somewhat different than Cap S. Specifically, while Cap S has a contour on the portion of the base 1502 that couples to the tube, Cap TT has a straight base 2002. Additionally, unlike Cap S, the bottom opening 2008 for Cap TT extends substantially to the edge of the base 2002 in the transverse direction. In one embodiment, Cap TT and Model TT is fabricated such that the combination of Cap TT and Model TT appears as a single integrated unit.

Otherwise, the functional operation of Cap TT is substantially similar to the functional operation of Cap S. As such, further discussion of the operation of Cap TT is omitted here.

### Tenth Embodiment of Cap (Cap STU)

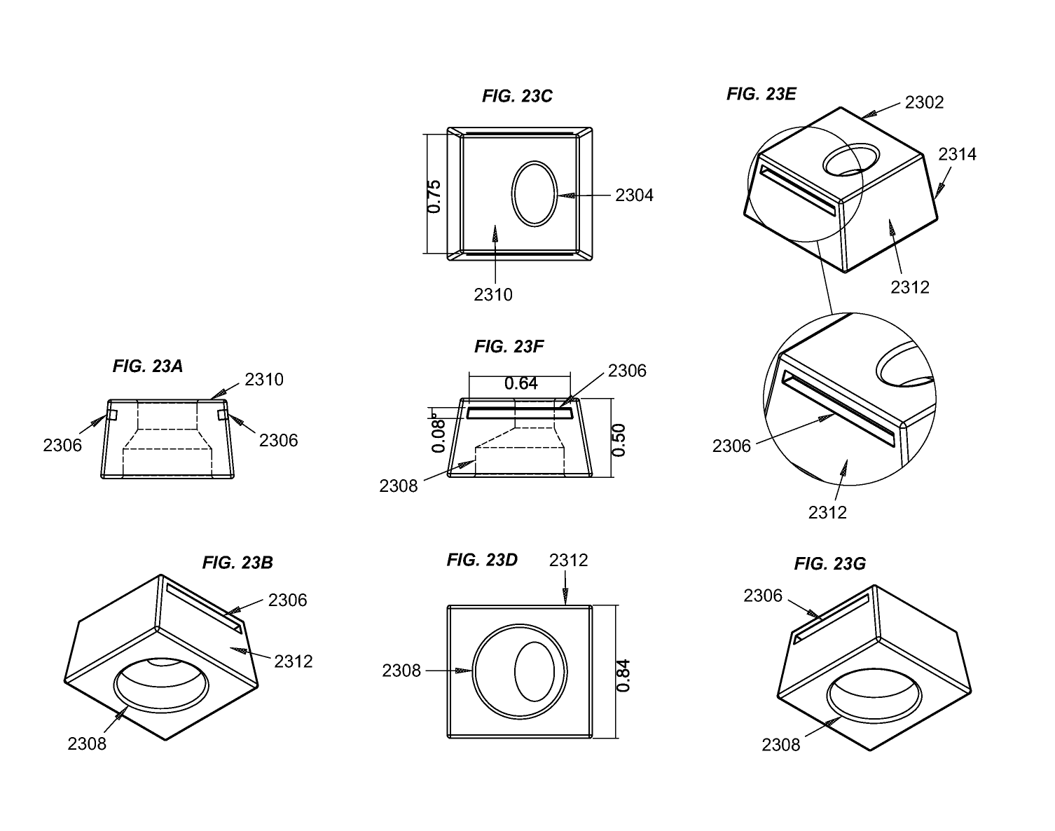

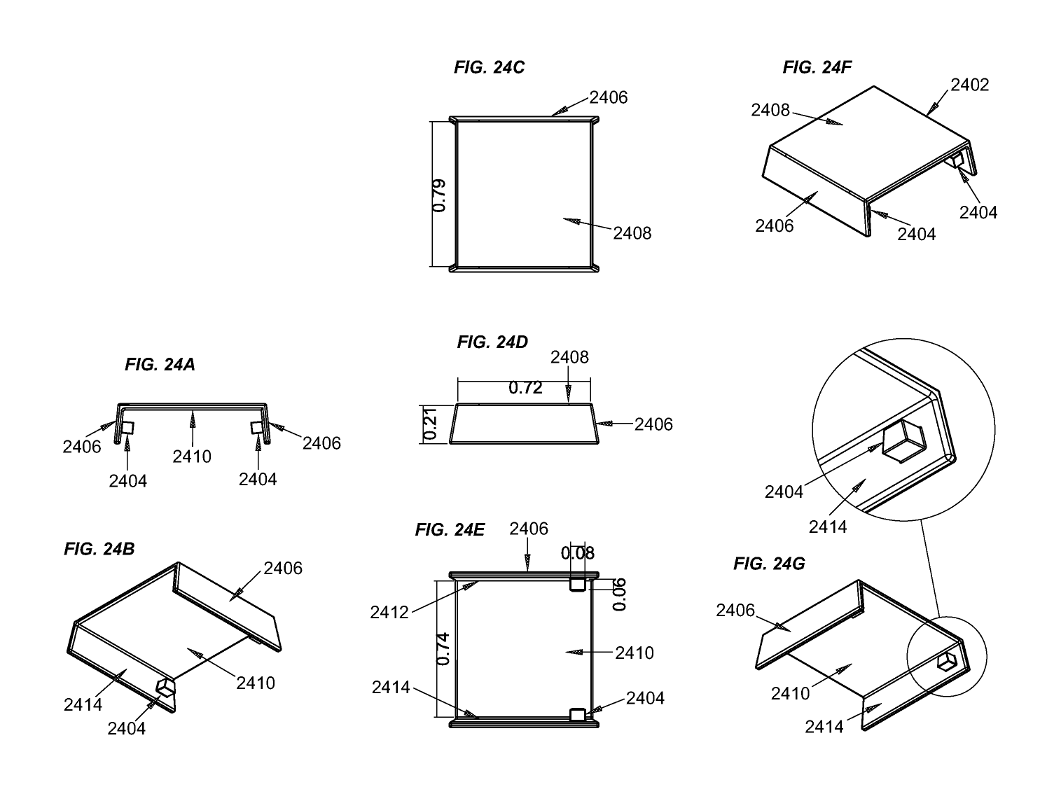

FIGS. 23A through 23G show a tenth embodiment of a base 2302 of a cap for a toothpaste tube. This base 2302 is compatible with Models CT 1702, RT 1802, TT 1902, and STU 2202. FIGS. 24A through 24G show one embodiment of a lid 2402 that couples to the base 2302 of FIGS. 23A through 23G. For the sake of clarity, this embodiment of the cap is referred to herein as Cap STU.

Cap STU is somewhat different from both Cap S and Cap TT in some features, yet similar to Cap S and Cap TT in other features. Specifically, while Cap S has a contour on the portion of the base 1502 that couples to the tube, Cap STU has a straight base 2302 similar to that of Cap TT. Additionally, similar to Cap S but dissimilar to Cap TT, the bottom opening 2308 for Cap STU does not extend substantially to the edge of the base 2302 in either the transverse direction or the longitudinal direction.

As discussed above, with reference to Model STU, the base of Cap STU tapers to fit the shape of Model STU so that the combination of Cap STU and Model STU appears as one integrated unit, similar to how Cap TT and tube TT appear, in combination, as a single integrated unit. For the embodiments shown herein, it is noteworthy that Cap TT is tapered on the left & right sides, but straight on the top & bottom. Cap STU, however, is tapered on all four sides to fit Model STU.

Cap STU also has an oval-shaped top opening 2304 on the base 2302, unlike the substantially rectangular or square-shaped openings in the other two cap designs. One can imagine that the opening can be configured to take on any shape, whether it be circular, oval, square, rectangular, or any other polygonal or organic shape.

Since the functional operation of Cap STU is substantially similar to the functional operation of both Cap S and Cap TT, only a truncated discussion of the functional features of Cap STU is provided herein.

### Eleventh Embodiment of Cap (Cap TS)

FIGS. 26A through 26F show an eleventh embodiment of a base 2602 of a cap for a toothpaste tube. This base 2602 is compatible with Model TS 2502. FIGS. 27A through 27F show one embodiment of a lid 2702 that couples to the base 2602 of FIGS. 26A through 26F. For the sake of clarity, this embodiment of the cap is referred to herein as Cap TS.

The cap comprises a base 2602 and a lid 2702. The base 2602 houses a top opening 2604 from which the toothpaste is expelled. Additionally, the base 2602 includes tracks 2606 that operatively couple the base 2602 to the lid 2702. At the bottom, the base 2602 has a circular opening 2608 that couples the cap to the tube.

The lid 2702 comprises two separate pegs 2704 that are inserted into the two separate tracks 2606 in the base 2602, thereby permitting the lid 2702 to slide longitudinally with reference to the base 2602.

While the sliding operation of Cap TS is similar to the sliding operation of Cap S, Cap TT, Cap STU, Cap C, or Cap G, the elongated structure of Cap TS poses different engineering challenges from those other caps. For example, due to its elongated structure, the pegs 2704 should be longer in the longitudinal direction in order to provide more stability as the lid 2702 slides along the base 2602.

One can readily notice that, due to the elongated structure, the bottom opening 2608 on Cap TS is rectangular, rather than circular. Thus, unlike some of the other embodiments, described above, Cap TS is configured to snap onto the top of the tube, rather than screwing onto the top of the tube. For different embodiments or configurations, Cap TS can be configured to partially twist onto the top, and then snap on securely. Alternatively, with proper design, Cap TS can also be configured to twist (or screw) onto the top of Model TS.

Since the functional operation of the sliding lid is described in detail above, and since one can readily extrapolate how Cap TS operates in view of the descriptions above, further discussion of the functional operation of Cap TS is omitted here.

### Embodiments of Grips

FIGS. 30A through 30J show various embodiments of grips for different lids of caps. As shown in FIG. 30, for some embodiments, the profile of the grip exhibits a sawtooth 3002 pattern. It should be appreciated that any profile that increases traction can be used, and the invention is not limited to a sawtooth 3002 profile. For illustrative purposes, various grip designs are shown with reference to Cap TT, Cap STU, Cap TS, and Cap S.

In Cap TT, the top surface 2108 of the lid 2102 can include a grip. For some embodiments, the grip can follow a pattern, such as an arrow 3004, to provide the user with information on the correct direction to open the cap by the visual or tactile senses. It should be appreciated that the grip pattern on the surface 2108 can be any size or shape. For example, in some embodiments the arrow 3004 can be slightly raised above the surface 2108 of the lid 2102. In other embodiments, the grips can be constructed by carving grooves or indentations into the surface, rather than raising the surface. In yet other embodiments, the sides 2102 of the lid could also bear 3006 a grip.

The grip, for some embodiments, can be made of different material (e.g., rubber) that would provide sufficient traction under wet or dry conditions. Additionally, the grip may or may not be shaped into various patterns for aesthetic or functional reasons. In some embodiments, the lid and grip can be fabricated using a combination of two or more materials. For example, the lid can be fabricated out of plastic while the grip is fabricated out of rubber.

In Cap STU, as shown in FIGS. 30B through 30D, the top surface 2408 of the lid 2402 may be raised to create the grip. For some embodiments, the sides 3010 of the lid 2402 can be indented for the fingers. These indented sides 3010 may include a grip for some embodiments, but need not in other embodiments.

In addition to the grip, it should be appreciated that the lids can also optionally include a stump to assist in the opening and closing of the lid.

FIGS. 30E through 30G show examples of how the grip can be applied to Cap TS. As seen here, the grips can be located on the top 3016 or along the sides 3012. It should be appreciated that the grip can be located throughout the entire length of the side 3012 of the lid 2702, similar to the embodiment shown in FIGS. 30E and 30G. In other embodiments, the side grip can be located strategically in only a portion of the side 3014, such as that shown in FIG. 30F. The same can be said of any grip that is situated on the top 3016 of the lid 2702.

FIGS. 30H through 30J show examples of grips that are applied to Cap S. As shown in FIGS. 30H through 30J, the shape of the grips can be altered to change the aesthetic appeal of the lid. In addition, the shape of the grips can be altered to provide the user with information on the proper direction in which the lid would slide with reference to the base. As one can readily see, there are countless variations on how a grip can be applied to the lid. It is intended that the grip designs shown in FIG. 30 be examples, and not as limitations on the invention.

Although exemplary embodiments have been shown and described, it will be clear to those of ordinary skill in the art that a number of changes, modifications, or alterations to the invention as described may be made. For example, while specific dimensions and measurements have been disclosed in some of the drawings, it should be understood that those dimensions and measurements can be altered or modified without detrimentally affecting the inventive concepts.

Additionally, while specific embodiments show toothpaste dispensers, it should be appreciated that the inventive concept is not limited to toothpaste, but is intended to encompass any type of pastes, gels, and/or other viscous fluids. Furthermore, while the various embodiments show the base having a track and the lid of the cap having a peg, it should be appreciated that the peg can be located on the base and its corresponding track located on the lid.

Also, while the embodiments show the lid longitudinally or transversely sliding with reference to the base, it should be appreciated that the lid may pivotally slide with reference to the base, slide diagonally at an angle, slight or prominent, or along a curvature, which may or may not be at an angle diagonally.

The front and back openings of the base can vary in shape and size. For example, the opening can be circular, oval, square, or any other polygonal or organic shape. Additionally, the sides of the base can be tapered (as shown in the drawings) or straight (not shown). The cap can vary in shape and size, and the cap can be more rounded off on the edges if desired. In yet other embodiments, the base of the cap can be convex at the top, thereby permitting the lid to slide at a curvature that follows the convex contours of the base.

In other embodiments, the tracks can have some obstruction to prevent the pegs from sliding off the base, and, in some cases, preventing the lids from becoming detached from their respective bases. This obstruction can vary in size and shape.

All such changes, modifications, and alterations should therefore be seen as within the scope of the disclosure.

What is claimed is:

1. A dispenser for dispensing viscous fluids, the dispenser comprising:
a side; and
a crease located on the side, the crease being configured to facilitate inward folding of the side.

2. The dispenser of claim 1, further comprising:
a pliable wall having a curved edge, the curved edge being flexibly coupled to one edge of the side.

3. The dispenser of claim 1, further comprising:
a pliable wall having a substantially rectangular shape, the pliable wall being flexibly coupled to one edge of the side.

4. The dispenser of claim 1, further comprising:
a pliable wall having a substantially-straight edge, the substantially-straight edge being flexibly coupled to one edge of the side.

5. The dispenser of claim 1, further comprising:
a pliable wall having a substantially triangular shape, the pliable wall being flexibly coupled to one edge of the side.

6. The dispenser of claim 1, further comprising:
a pliable wall having a substantially trapezoidal shape, the pliable wall being flexibly coupled to one edge of the side.

7. The dispenser of claim 1, further comprising:
a first substantially-rigid wall, the first wall being flexibly coupled to one edge of the side;
a second substantially-rigid wall, the second wall being flexibly coupled to another edge of the side

8. A cap for a dispenser of a viscous fluid, the cap comprising:
a base; and
a lid, the lid being slidably coupled to the base.

9. The cap of claim 8, further comprising:
a track on the base; and
a peg on the lid, the peg being configured to couple to the track, the peg and the track permitting lateral movement of the lid with reference to the base.

10. The cap of claim 9, the track permitting longitudinal lateral movement with reference to the base.

11. The cap of claim 9, the track permitting transverse lateral movement with reference to the base.

12. The cap of claim 8, the lid being configured to pivotally slide with reference to the base.

13. The cap of claim 8, further comprising:
tracks on the base; and
pegs on the lid, each peg being configured to couple to one of the tracks on the base, the pegs and the tracks permitting lateral movement of the lid with reference to the base.

14. The cap of claim 8, further comprising:
tracks on the lid; and
pegs on the base, each peg being configured to couple to one of the tracks on the lid, the pegs and the tracks permitting lateral movement of the lid with reference to the base.

15. The cap of claim 13, further comprising:
a stump located on the lid.

16. The cap of claim 13, further comprising:
a grip located on the lid, the grip providing increased traction.

17. The cap of claim 8, further comprising an opening located on the base, the opening being substantially circular.

18. The cap of claim 8, further comprising an opening located on the base, the opening being substantially non-circular.

19. The cap of claim 8, further comprising an opening located on the base, the opening being located substantially center of the base.

20. The cap of claim 8, further comprising an opening located on the base, the opening being located off-center of the base.
